(19) United States
(12) Patent Application Publication
(10) Pub. No.: US 2009/0208830 A1
(43) Pub. Date: Aug. 20, 2009

(54) Lead for sealed battery, sealed battery using the same and method of manufacturing the same

(75) Inventors: Kazuya Okabe, Kyoto (JP); Satoshi Yokota, Kyoto (JP); Takahiro Itagaki, Kyoto (JP); Tomonori Kishimoto, Kyoto (JP); Shuichi Izuchi, Kyoto (JP)

Correspondence Address: KANESAKA BERNER AND PARTNERS LLP, 1700 DIAGONAL RD, SUITE 310, ALEXANDRIA, VA, 22314-2848, US

(73) Assignee: GS YUASA CORPORATION, Kyoto-shi (JP)

(21) Appl. No.: 11/921,417

(22) PCT Filed: May 26, 2006
(86) PCT No.: PCT/JP2006/311049

§ 371 Date: Nov. 30, 2007

(30) Foreign Application Priority Data
May 30, 2005 (JP) 2005-157487

(51) Int. Cl. H01M 2/26

(52) U.S. Cl. 429/121; 29/623.2

(57) ABSTRACT

A lead for a sealed battery having a specific profile can realize a low resistance welding process when connecting the upper current collecting plate and the lid in order to make the sealed battery show a low resistance and excellent output characteristics. A sealed battery is realized by using such a lead and a method of manufacturing such a battery employs a specific welding step.

A lead for a sealed battery to be used by welding the inner surface of the lid of the sealed battery and the upper surface of an upper current collecting plate is characterized in that the lead comprises a plate-shaped top part (20-1) and a lateral wall part (20-2) extending obliquely downwardly from the outer periphery of the top part (20-1) so as to expand or the lateral wall part (20-2) and a flange portion (30) provided at the outer periphery of the lower end thereof and that slits (20-4) are formed in the lateral wall part (20-2) and the flange portion (30) of the lead to extend longitudinally from the lower end thereof and at circumferential intervals. Additionally, a lead is characterized in that the lead comprises a plate-shaped frame part (21-1) and a lateral wall part (21-2) extending obliquely downwardly from the inner periphery of the frame part (21-1) so as to contract or the lateral wall part (21-2) and a bottom (31) projecting from the inner periphery of the lower end thereof and that slits are formed in the lateral wall part (21-2) and the bottom (31) to extend longitudinally from the lower end thereof and at circumferential intervals. A sealed battery is formed by using such a lead. A assembled battery is formed by using a plurality of such batteries. A method of manufacturing a sealed battery comprises a specific welding step.

### TECHNICAL FIELD

This intention relates to a lead for a sealed battery, a sealed battery using such a lead and a method of manufacturing such a battery. Specifically, the present invention relates to the improvement of a sealed battery that connects a current collecting plate and a lid through a lead.

### BACKGROUND ART

Generally, an alkali battery such as a nickel-hydride battery, a nickel-cadmium battery or the like has a power generating element contained in a battery case that also operates as a terminal of one of the electrodes of the battery. For instance, there has been proposed a battery in which a current collector 101 is molded integrally with a current collecting lead 103 extending from it and having a thickness same as the current collector 101 as shown in FIG. 31 of the accompanying drawings.

In such a battery, as shown in FIG. 32, a power generating element is formed by arranging a separator 10 between a positive electrode plate 8 and a negative electrode plate 9, winding them to a roll and containing them in a packaging container 6, which is a metal battery case, with a current collecting lead 103 welded to a sealing body at a spot. Subsequently, the sealing body 11 is fitted to the battery case 6 by way of an insulating gasket to close the opening of the battery case 6 and hermetically seal the battery.

When such an alkali battery is put to use in an application that is required to operate with a high rate charge/discharge cycle such as an electric motor-driven tool or an electric vehicle, the electric resistance of the current collector connecting between the power generating element and the sealing body significantly affect the performance of the battery. The internal resistance of the battery needs to be minimized in such applications because the battery is required to flow a large electric current in the charge/discharge cycle.

Batteries designed to minimize the internal resistance include the one described in the following document (refer to, e.g., Patent Document 1).

Patent Document 1: JP-A 2004-63272 (FIGS. 1 through 4, 10, 11 and paragraphs [0022] through [0038])

A nickel-cadmium battery designed to minimize the internal resistance as disclosed in Patent Document 1 will be described below.

FIG. 33 is a schematic perspective view of a principal part of the nickel-cadmium battery containing a current collector integrally formed with a current collecting lead by punching and FIGS. 34A and 34B are a schematic plan view and a schematic cross-sectional view of the current collector 1. The current collector 1 is made of a nickel-plated iron plate having a thickness of 0.3 mm and includes a flat portion 2 and a protruded portion 3 which is produced by punching to show a height of about 2.0 mm.

The current collector is characterized in that the collector is substantially disk-shaped and includes a protruded portion 3, which has at the top thereof a thinned region 4 that can serve as welding region.

The flat portion has holes 5, each of which is provided at the peripheral edge thereof with fins 5B projecting downward from the rear surface of the flat portion so as to operate as so many points welded to be welded to the positive electrode plate. FIG. 35 is a schematic cross-sectional view of the battery in a state where an electrode assembly is put into the battery case 6, or the packaging container, and welded to the sealing body by way of the current collector 1.

As shown in FIG. 35, the nickel-cadmium battery is prepared by containing a battery element formed by arranging a separator 10 between a nickel positive electrode plate 8 and a cadmium negative electrode plate 9 and winding them to a roll in a battery case 6, which is a cylindrical container with a bottom, placing a current collector 1 thereon and welding a sealing body 11 to the protruded portion 3 by direct welding for electric connection.

The sealing body 11 includes a lid body 12, a positive electrode cap 13 and a valve body interposed between the lid body 12 and the positive electrode cap 13 and formed by a spring 15 and a valve plate 14. A vent hole 16 is formed through the center of the lid body 12.

Fins 5B are formed at the peripheral edges of the holes 5, which are cut through the flat portion 2 of the current collector 1, before being welded to the sealing body so as to project at the rear surface side. The fins operate as points welded where the current collector is welded to the positive electrode plate 8. On the other hand, a disk-shaped negative electrode current collector 7 is arranged at the bottom of the battery case 6 and welded to the negative electrode plate 9 for electric connection. The open-end portion 17 of the battery case 6 is sealed by crimping.

With the above-described arrangement, welding regions can be formed easily and reliably simply by processing a single disk-shaped metal plate by punching to reliably establish electric connection.

Additionally, the flat portion 2 operates as current collector main body section to be connected to an electrode while the protruded portion 3 operates as current collecting lead to be connected to the positive electrode side terminal, which is the sealing body. Thus, the connection resistance is reduced as the flat portion 2 and the protruded portion 3 are integrally formed.

Additionally, since the top surface area 4 of the protruded portion 3 is made thin as shown in FIG. 34B, the welding current can be concentrated there during the welding process. Furthermore, since the area 4 is made resilient so that the welded area is reliably subjected to pressure to make the electric connection even more reliable.

However, while the lead of the above-described battery can be made short, it is not possible to increase the thickness of the lead and reduce the electric resistance of the lead itself because it is produced by punching a single disk-shaped metal plate so that the effect of reducing the internal resistance is far from satisfactory.

Additionally, it is difficult to reduce the distance between the lid and the upper current collecting plate for reasons relating to the manufacturing process and hence products can often turn out to be defective.

Still additionally, a battery as described above can show welding defects because it is welded to a thick lid by current-carrying through the battery, which is relatively less reliable.

Other batteries designed to reduce the internal resistance include the following (refer to, e.g., Patent Documents 2 and 3).

Patent Document 2: JP-A 2001-345088 (FIG. 2; FIG. 36 of the accompanying drawings of this specification)
Patent Document 3: JP-A 2001-155710 (FIGS. 3 and 4; FIGS. 37 and 38 of the accompanying drawings of this specification)

Patent Document 2 describes a battery designed to reduce the internal resistance and having a structure as shown in FIG. 36. The battery employs a welding process where “a vortex-shaped electrode assembly is prepared by winding a nickel positive electrode plate 1 and a negative electrode plate 2 made of a hydrogen absorbing alloy with a separator 3 interposed between them and welding a positive electrode current collector 4 and a negative electrode current collector (not shown) to the electrode plate cores exposed at the upper surface of the vortex-shaped electrode assembly and the electrode plate cores exposed at the lower surface of the vortex-shaped electrode assembly respectively. Then, a lead for the positive electrode 5 that is bent so as to make a central part thereof show a cylindrical profile is welded to an upper part of the positive electrode current collector 4 and the above components are contained in a bottomed cylindrical packaging can (the outer surface of the bottom of which serves as negative electrode external terminal) 6 that is made of iron and nickel-plated while the negative electrode current collector welded to the negative electrode plate 2 made of a hydrogen absorbing alloy is further welded to the inner bottom surface of the packaging can 6” (paragraph [0026]).

While the electric resistance of the battery described in Patent Document 2 can be reduced because a double lead is extended from each of the current collecting plates without making the lead thick, the reduction of the electric resistance is limited because the current collecting plates cannot be made thicker.

Additionally, since the packaging can 6 needs to be welded to a thick lid, a large electric current is required for the welding operation. When the thickness is not enough, the leads are softened by heat to make it difficult to keep the tight adhesion of the welded spots. Then, the welding becomes less reliable to give rise to a problem of varied quality of welding. In other words, the number of welded spots has to be limited and hence the effect of reducing the internal resistance is not satisfactory.

Additionally, the round current collecting plates require a long lead and hence, again, the effect of reducing the internal resistance is not satisfactory.

Patent Document 3 also describes a battery designed to reduce the internal resistance. As shown in FIGS. 37 and 38, the battery includes a battery case 16 having an open-end portion and adapted to serve as the terminal of one of the electrodes, a sealing body 17 (a lid body 17a, a positive electrode cap 17b, a spring 17c, a valve body 17d) adapted to hermetically seal the battery case 16 by closing the open-end portion and serve as the terminal of the other electrode, an electrode assembly 10 of a positive electrode plate 11 and a negative electrode plate 12 that are contained in the battery case 16 and connected to a current collector 14 at least at one of the opposite ends thereof. The sealing body 17 and the current collector 14 are rigidly secured and electrically connected to each other by way of a lead portion in the form of a drum body 20 showing a concaved profile at the longitudinal middle part thereof. The drum body 20 has upper and lower flange portions 22 and 23 at the upper and lower ends thereof. The flange portions 22 and 23 have broad edge portions 22a and 23a and narrow edge portions 22b and 23b that are arranged alternately in such a way that the broad edge portions 22a and the narrow edge portions 23b are located vis-à-vis with a space separating them, while the narrow edge portions 22b and the broad edge portions 23a are located vis-à-vis with a space separating them.

The Patent Document also describes a method of preparing a cylindrical nickel-hydrogen storage battery having a nominal capacity of 6.5 Ah by welding before and after a sealing process in a manner as described below.

Firstly, the above-described drum body 20 is placed on the positive electrode current collector 14 and a welder electrode (not shown) is arranged along the outer peripheries of the narrow edge portions 22b of the upper flange portion 22 to weld the broad edge portions 23a of the lower flange portion 23 and the current collector 14 by spot welding. Thereafter, the electrode assembly 10 whose positive electrode current collector 14 is welded to the drum body 20 is contained in the battery case (the outer surface of the bottom thereof serves as negative electrode external terminal) 16 with a bottom that is made of iron and nickel-plated. (paragraph [0029])

Subsequently, an insulating gasket is fitted to peripheral edge of the sealing body 17 for mutual engagement and the sealing body 17 is pushed into the battery case 16 by applying pressure to the sealing body 17 by means of a press machine until the lower end of the insulating gasket gets to the position of the recessed section 16a of the battery case. Then, the battery was sealed by inwardly crimping the edge of the opening of the battery case 16. The main body portion 21 of the drum body 20 is crushed at the concaved middle part to become flat under the pressure applied to seal the battery. Then, one of the welder electrodes, or the welder electrode W1, is arranged on the upper surface of the positive electrode cap (positive electrode external terminal) 17a while the other welder electrode W2 is arranged on the lower surface of the bottom (negative electrode external terminal) of the battery case 16. (paragraph [0031])

Thereafter, a voltage of 24V is applied between the pair of welder electrodes W1 and W2 in the discharging direction of the battery while applying pressure of 2×10⁶/m² between the welder electrodes W1 and W2 for an electric current-carrying process, where an electric current of 3 KA was made to flow for about 15 msec. As a result of the electric current-carrying process, the electric current is concentrated to the contact areas of the bottom of the sealing body 17 and the small projections 22c formed in the broad edge portions 22a of the upper flange portion 22 of the drum body 20 so that the small projections 22c and the bottom of the sealing body 17 are welded to produce welded sections. At the same time, the lower surface of the negative electrode current collector 15 and the top surface of the bottom (negative electrode external terminal) of the battery case 16 are welded to produce welded sections. (paragraph [0032])

However, the above-described battery is accompanied by problems including that the welded spots of the positive electrode current collector (upper current collecting plate) can be damaged to degrade the reliability of welding and make the resistance of the lead dispersive to a large extent when a large electric current is made to flow at the time of the welding process in order to weld the thick sealing body (lid) to the drum body (lead) and that the lead is softened by heat to make it difficult to keep the contact pressure of the contact spots to the welded areas to consequently degrade the reliability of welding and make the welding variable. For these reasons, again, the effect of reducing the internal resistance is not satisfactory.

Batteries designed to reduce the internal resistance by forming an electric conduction channel include the following (refer to, e.g., Patent Documents 4 through 6).

Patent Document 4: JP-A 2004-259624 (FIG. 1; FIG. 39 of the accompanying drawings of this specification)
Patent Document 5: JP-A 2004-235036 (FIGS. 6, 14 and 15; FIGS. 40, 41 and 42 of the accompanying drawings of this specification)
Patent Document 6: JP-A 10-261397 (FIG. 1; FIG. 43 of the accompanying drawings of this specification)

Patent Documents 4 through 6 describe batteries where the current collecting resistance can be reduced as, for instance, a shortened electric conduction channel is formed by welding a current collecting lead between a terminal and an electrode, subsequently sealing the battery and pressing down the region for forming a crimping part so as to bring the projecting parts of the current collecting leads into contact with opposite surfaces.

However, while the current collecting leads are deformed under pressure to produce a shortened electric conduction channel in the internal space, a reactive current is apt to flow through some other channels when welding them to contact spots to form a shortened electric conduction channel so that the welding process does not give rise to reliable results and the resistance can become dispersive.

Additionally, since the battery is exposed to the potential of the positive electrode, a film coat can be formed on the shortened electric channel due to oxidation to gradually increase the resistance in operation.

The edge 16b of the opening of the packaging container 16 is inwardly bent for crimping and welded before the battery of Patent Document 5 is sealed. Therefore, the produced electric conduction channel is not satisfactorily short and the battery is accompanied by a drawback of a relatively high resistance.

The method of preparing a battery as described in Patent Document 6 includes a step of sealing the opening of the battery case by means of a sealing body and a step of forming welded sections by welding the contact areas of the current collecting lead plate and the sealing body by passing an electric current between the battery case and the sealing body after the sealing step to make it possible to mount the sealing body onto the opening of the packaging container if the current collecting lead is short and reduce the current collecting distance and hence the internal resistance of the battery. Additionally, since it is not necessary to bend the current collecting lead of this battery at the time of sealing, a thick current collecting lead can be used to reduce the internal resistance of the battery.

However, with the above-described welding method, the current collecting lead plate drawn out from either the positive electrode or the negative electrode is partly brought into contact with the lower surface of the sealing body and the current collecting lead plate and the sealing body are welded at the contact areas to produce welded sections so that the welding process is not reliable. Additionally, the current collecting structure of the battery is not enough for absorbing the variances of height. In other words, when the electrode bodies contained in the packaging container show variances of height, there can be a situation where contact areas cannot be reliably produced between the sealing body and the current collecting lead to make it difficult to reliably form welded sections.

### DISCLOSURE OF THE INVENTION

### Problems to be Solved by the Invention

As pointed out above, known batteries where the upper surface of the upper current collecting plate and the inner surface of the sealing body (lid) are welded by way of a lead are accompanied by a problem that the lead is made long to increase the electric resistance because the lid is put to close the battery after the welding process.

While some known batteries have a short lead, the lead is formed when the current collecting plate is produced by way of a punching process so that it is not possible to make the lead thicker than the current collecting plate. Thus, the resistance is consequently large.

When the lead is made to show a round profile, the distance between points welded becomes long to consequently raise the electric resistance.

While the electric conduction channel of some known batteries are made short as a result of the welding process by passing an electric current after hermetically sealing the battery, the thick lid and the lead are welded by the electric current-carrying through the battery or a reactive current flows because current flowing channels are found out of the contact areas for welding to make the welding process a difficult one and give rise to variances to the electric resistance.

Therefore, the object of the present invention is to provide a lead for a sealed battery having a specific profile that can realize a low resistance welding process when connecting the upper current collecting plate and the sealing body (lid) in order to make the sealed battery show a low resistance and excellent output characteristics, a sealed battery using such a lead and a method of manufacturing a battery employing a specific welding step.

### Means for Solving the Problems

As a result of intensive research efforts, the inventors of the present invention found that the above-identified problems can be dissolved and the voltage loss can be minimized by using a lead of a specific profile. The present invention is completed on the basis of the finding.

The present invention provides the following to dissolve the above-identified problems.

(1) A lead for a sealed battery to be used by welding the inner surface of the lid of the sealed battery and the upper surface of an upper current collecting plate, characterized in that the lead comprises: a plate-shaped top part; a lateral wall part extending obliquely downwardly from the outer periphery of said top part so as to expand; and that slits are longitudinally formed in said lateral wall part from the lower end at circumferential intervals.
(2) The lead for a sealed battery as defined in (1) above, characterized in that the lead further comprises a flange portion arranged at the outer periphery of the lower end of said lateral wall part and slits are longitudinally formed in said lateral wall part and said flange portion from the lower ends at circumferential intervals.
(3) The lead for a sealed battery as defined in (1) or (2) above, characterized in that the structure thereof is such that the lead portions put between the slits of said lateral wall part or said lateral wall part and said flange portion are bent to expand outwardly when said lid and said upper current collecting plate are pressurized.
(4) The lead for a sealed battery as defined in any one of (1) through (3) above, characterized in that two or more than two of said slits are formed at circumferential and regular intervals and the portions put between the slits of the lower end of said lateral wall part or said flange portion have respective projections for welding.
(5) The lead for a sealed battery as defined in any one of (1) through (4) above, characterized in that said top part has two or more than two projections for welding.
(6) A lead for a sealed battery to be used by welding the inner surface of the lid of the sealed battery and the upper surface of an upper current collecting plate, characterized in that the lead includes: a plate-shaped frame part; a lateral wall part extending obliquely downwardly from the inner periphery of said frame part so as to contract; and that slits are longitudinally formed in said lateral wall part from the lower end at circumferential intervals.
(7) The lead for a sealed battery as defined in (6) above, characterized in that the lead further comprises a bottom portion projecting from the inner periphery of the lower end of said lateral wall part and slits are longitudinally formed in said lateral wall part and said bottom portion from the lower ends at circumferential intervals.
(8) The lead for a sealed battery as defined in (6) or (7) above, characterized in that the structure thereof is such that the lead portions put between the slits of said lateral wall part or said lateral wall part and said bottom portion are bent to contract inwardly when said lid and said upper current collecting plate are pressurized.
(9) The lead for a sealed battery as defined in any one of (6) through (8) above, characterized in that two or more than two of said slits are formed at circumferential and regular intervals and the portions put between the slits of the lower end of said lateral wall part or said bottom portion have respective projections for welding.
(10) The lead for a sealed battery as defined in any one of (6) through (9) above, characterized in that said frame part has two or more than two projections for welding.
(11) A sealed battery containing an electrode assembly including a positive electrode plate and a negative electrode plate in a container and arranging an upper current collecting plate on said electrode assembly, the top surface of said upper current collecting plate electrically connected to one of the electrodes of said electrode assembly being welded to the inner surface of the lid by way of a lead, characterized in that said lead comprises: a plate-shaped top part; a lateral wall part extending obliquely downwardly from the outer periphery of said top part so as to expand; that slits are longitudinally formed in said lateral wall part from the lower end at circumferential intervals; and that the top part of said lead is welded to the inner surface of said lid and the lower end of the lateral wall part of said lead is welded to the upper surface of said upper current collecting plate.
(12) The sealed battery as defined in (11) above, characterized in that said lead further includes a flange portion arranged at the outer periphery of the lower end of said lateral wall part and slits are longitudinally formed in said lateral wall part and said flange portion from the lower end at circumferential intervals and that the flange portion of said lead is welded to the upper surface of said upper current collecting plate.
(13) The sealed battery as defined in (11) or (12) above, characterized in that the lead portions put between the slits of said lateral wall part or said lateral wall part and said flange portion are bent to expand outwardly.
(14) The sealed battery as defined in any one of (11) through (13) above, characterized in that two or more than two slits of said lead are formed at circumferential and regular intervals and points welded with the upper surface of said upper current collecting plate are arranged at the portions put between the slits of the lower end of the lateral wall part or the flange portion of said lead.
(15) The sealed battery as defined in any one of (11) through (14) above, characterized in that two or more than two points welded are provided for welding the inner surface of said lid and the top part of said lead.
(16) A sealed battery containing an electrode assembly including a positive electrode plate in a container and arranging a negative electrode plate and an upper current collecting plate on said electrode assembly, the top surface of said upper current collecting plate electrically connected to one of the electrodes of said electrode assembly being welded to the inner surface of the lid by way of a lead, characterized in that said lead comprises: a plate-shaped frame part; a lateral wall part extending obliquely downwardly from the inner periphery of said frame part so as to contract; that slits are longitudinally formed in said lateral wall part from the lower end at circumferential intervals; and that the frame part of said lead is welded to the inner surface of said lid and the lower end of the lateral wall part of said lead is welded to the upper surface of said upper current collecting plate.
(17) The sealed battery as defined in (16) above, characterized in that said lead further includes a bottom portion projecting from the inner periphery of the lower end of said lateral wall part and slits are longitudinally formed in said lateral wall part and said bottom portion from the lower ends at circumferential intervals and that the bottom portion of said lead is welded to the upper surface of said upper current collecting plate.
(18) The sealed battery as defined in (16) or (17) above, characterized in that the lead portions put between the slits of said lateral wall part or said lateral wall part and said bottom portion are bent to contract inwardly.
(19) The sealed battery as defined in any one of (16) through (18) above, characterized in that two or more than two slits of said lead are formed at circumferential and regular intervals and points welded with the upper surface of said upper current collecting plate are arranged at the portions put between the slits of the lower end of the lateral wall part or the bottom portion of said lead.
(20) The sealed battery as defined in any one of (16) through (19) above, characterized in that two ore more than two points welded are provided for welding the inner surface of said lid and the frame part of said lead.
(21) A assembled battery characterized by being comprised of a plurality of sealed batteries as defined in any one of (11) through (20).
(22) A method of manufacturing a sealed battery in which the inner surface of the lid closing the container of the sealed battery and the upper surface of the upper current collecting plate are connected by way of a lead, characterized by including:

a first welding step of bringing in a thing as said lead which has a plate-shaped top part, a lateral wall part extending obliquely downwardly from the outer periphery of said top part so as to expand, and slits being longitudinally formed in said lateral wall part from the lower end at circumferential intervals, and welding the top part of said lead to the inner surface of said lid; and a second welding step of subsequently putting an electrode assembly bonded with the upper current collecting plate in said container so as to make said upper current collecting plate located at the open end side of said container, injecting an electrolyte solution, mounting said lid so as to make the lower end of the lateral wall part of said lead contact the upper surface of the said upper current collecting plate, hermitically closing said container, pressurizing, and then welding the lower end of the lateral wall part of said lead to the upper surface of said upper current collecting plate by passing a welding electric current between the positive and negative terminals of the sealed battery by way of the battery.

(23) The method of manufacturing a sealed battery as defined in (22) above, characterized in that the lead further includes a flange portion arranged at the outer periphery of the lower end of said lateral wall part and slits are longitudinally formed in said lateral wall part and said flange portion from the lower end at circumferential intervals and that the flange portion of said lead is welded to the upper surface of said upper current collecting plate.
(24) The method of manufacturing a sealed battery as defined in (22) or (23) above, characterized in that the lead portions put between the slits of said lateral wall part or said lateral wall part and said flange portion are bent to expand outwardly and absorb a deformation when said lid and said upper current collecting plate are pressurized.
(25) A method of manufacturing a sealed battery in which the inner surface of the lid closing the container of the sealed battery and the upper surface of the upper current collecting plate are connected by way of a lead, characterized by including: a first welding step of bringing in a thing as said lead which has a plate-shaped frame part, a lateral wall part extending obliquely downwardly from the inner periphery of said frame part so as to contract and slits being longitudinally formed in said lateral wall part from the lower end at circumferential intervals, and welding the frame part of said lead to the inner surface of said lid; and a second welding step of subsequently putting an electrode assembly bonded with the upper current collecting plate in said container so as to make said upper current collecting plate located at the open end side of the said container, injecting an electrolyte solution, mounting said lid so as to make the lower end of the lateral wall part of said lead contact the upper surface of said upper current collecting plate, hermitically closing said container, pressurizing, and then welding the lower end of the lateral wall part of said lead to the upper surface of said upper current collecting plate by passing a welding electric current between the positive and negative terminals of the sealed battery by way of the battery.
(26) The method of manufacturing a sealed battery as defined in (25) above, characterized in that the lead further includes a bottom portion projecting from the inner periphery of the lower end of said lateral wall part and slits are longitudinally formed in said lateral wall part and said bottom portion from the lower ends at circumferential intervals and that the bottom portion of said lead is welded to the upper surface of said upper current collecting plate.
(27) The method of manufacturing a sealed battery as defined in (25) or (26) above, characterized in that the lead portions put between the slits of said lateral wall part or said lateral wall part and said bottom portion are bent to contract inwardly and absorb a deformation when said lid and said upper current collecting plate are pressurized.

A slit as used herein divides the lateral wall part and/or the flange portion or the bottom and there are no limitations to the profile thereof.

### ADVANTAGES OF THE INVENTION

Thus, according to the present invention, a lead having a plate-shaped top part and a lateral wall part extending obliquely downwardly from the outer periphery of the top part so as to expand or a plate-shaped frame part and a lateral wall part extending obliquely downwardly from the inner periphery of the frame part so as to contract is used and slits are formed in the lateral wall part so that the lateral wall part may be bent. With this arrangement, it is possible to realize a cylindrical battery showing very excellent output characteristics that can conventionally be achieved only by expensive polygonal nickel-hydrogen batteries that have a special structure and employ an expensive lead having a special structure.

### BRIEF DESCRIPTION OF THE DRAWINGS

FIG. 1 is a schematic perspective view of a lead (Example 3) having a top part (with eight welding projections) and a lateral wall part and a flange portion (with eight welding projections), where slits are formed;

FIG. 2 is a schematic perspective view of a lead (rear side) having a top part (with eight welding projections), and a lateral wall part and a flange portion (with eight welding projections), where slits are formed;

FIG. 3 is a schematic perspective view of a lead (Example 2) having a top part (with 16 welding projections), and a lateral wall part and a flange portion (with eight welding projections), where slits are formed;

FIG. 4 is a schematic perspective view of a lead having a top part (with four welding projections), and a lateral wall part and a flange portion (with eight welding projections), where slits are formed;

FIG. 5 is a schematic perspective view of a lead (Example 1) having a top part (with four welding projections), and a lateral wall part and a flange portion (with four welding projections), where slits are formed;

FIG. 6 is a schematic perspective view of a lead having a top part (with four welding projections and slits), and a lateral wall part and a flange portion (with four welding projections), where slits are formed;

FIG. 7 is a schematic perspective view of a lead having a top part (with four welding projections) and a lateral wall part and a flange portion (with four welding projections), where (broad) slits are formed;

FIG. 8 is a schematic perspective view of a lead having a top part (with four welding projections), and a lateral wall part and a flange portion (with four welding projections), where (narrow) slits are formed;

FIG. 9 is a schematic perspective view of a lead having a top part (with two welding projections), and a lateral wall part and a flange portion (with four welding projections), where slits are formed;

FIG. 10 is a schematic perspective view of a lead (Example 4) having a top part (with two welding projections), and a lateral wall part and a flange portion (with two welding projections), where slits are formed;

FIG. 11 is a schematic perspective view of a lead (Example 5) having a top part (with eight welding projections and slits), and a lateral wall part and a flange portion (with eight welding projections), where slits are formed;

FIG. 12 is a schematic perspective view of a lead having a top part (with eight welding projections) and a lateral wall part (with eight welding projections), where slits are formed;

FIG. 13 is a schematic perspective view of a lead (Example 6) having a frame part (with four welding projections), and a lateral wall part and a bottom (with tour welding projections), where slits are formed;

FIG. 14 is a schematic perspective view of a lead (rear side) having a frame part (with four welding projections), and a lateral wall part and a bottom (with four welding projections), where slits are formed;

FIG. 15 is a schematic perspective view of a lead (Example 7) having a frame part (with sixteen welding projections), and a lateral wall part and a bottom (with eight welding projections), where slits are formed;

FIG. 16 is a schematic perspective view of a lead (Example 8) having a frame part (With eight welding projections), and a lateral wall part and a bottom (with eight welding projections), where slits are formed;

FIG. 17 is a schematic perspective view of a lead having a frame part (with eight welding projections), and a lateral wall part and a bottom (with four welding projections), where slits are formed;

FIG. 18 is a schematic perspective view of a lead having a frame part (with four welding projections), and a lateral wall part and a bottom (with four welding projections), where slits are formed;

FIG. 19 is a schematic perspective view of a lead having a frame part (with four welding projections), and a lateral wall part and a bottom (with two welding projections), where slits are formed;

FIG. 20 is a schematic perspective view of a lead (Example 9) having a frame part (with two welding projections), and a lateral wall part and a bottom (with two welding projections), where slits are formed;

FIG. 21 is a schematic perspective view of a lead (Example 10) having a frame part (with eight welding projections and slits), and a lateral wall part and a bottom (with eight welding projections), where slits are formed;

FIG. 22 is a schematic perspective view of a lead having a frame part (with four welding projections), and a lateral wall part (with four welding projections), where slits are formed;

FIG. 23 is a schematic illustration of bends of lead portions put between slits of a lateral wall part and a flange portion absorbing a vertical positional displacement when the lead welded to a lid is further welded to an upper current collecting plate (and an electrode assembly having a large height is provided);

FIG. 24 is a schematic illustration of bends of lead portions put between slits of a lateral wall part and a flange portion absorbing a vertical positional displacement when the lead welded to a lid is further welded to an upper current collecting plate (and an electrode assembly having a standard height is provided);

FIG. 25 is a schematic illustration of bends of lead portions put between slits of a lateral wall part and a flange portion absorbing a vertical positional displacement when the lead welded to a lid is further welded to an upper current collecting plate (and an electrode assembly having a small height is provided);

FIG. 26 is a schematic illustration of a sealed battery where a lead (having a frame part and a lateral wall part having slits formed therein) welded to a lid is further welded to an upper current collecting plate;

FIG. 27 is a schematic illustration of a sealed battery where a lead having a frame part, a lateral wall part and a bottom having slits formed therein is welded to a lid and an upper current collecting plate (at a welding position located outside relative to the end of a cap);

FIG. 28 is a schematic illustration of a sealed battery where a lead having a frame part, a lateral wall part and a bottom, slits being formed in the lateral wall part and the bottom, is welded to a lid and an upper current collecting plate (at a welding position located inside relative to the end of a cap) (Examples 6 through 10, Comparative Example 3);

FIG. 29 is a schematic illustration of a sealed battery where a lead having a top part, a lateral wall part and a flange portion, slits being formed in the lateral wall part and the flange portion, is welded to a lid and an upper current collecting plate (at a welding position located inside relative to the end of a cap) (Examples 1 through 5, Comparative Example 2);

FIG. 30 is a schematic illustration of a known ribbon-shaped lead (Comparative Example 1);

FIG. 31 is a schematic perspective view of a known current collecting structure where a current collecting lead is extended from and integrally formed with a current collector to show a same thickness;

FIG. 32 is a schematic cross-sectional view of a known sealed battery completed by welding a current collecting lead as shown in FIG. 31 to a sealing body;

FIG. 33 is a schematic perspective view of a known nickel-cadmium battery mounted with a current collector integrally formed by means of a punching process;

FIGS. 34A and 34B are a schematic plan view and a cross-sectional view of a known current collector integrally formed by means of a punching process;

FIG. 35 is a schematic cross-sectional view of a known sealed battery where an electrode body is put into a battery case and welded to a sealing body by way of a current collector as shown in FIGS. 34A and 34B;

FIG. 36 is a schematic cross-sectional view of a known cylindrical lead welded to a positive electrode current collector;

FIGS. 37A, 37B and 37C are a schematic plan view, a schematic lateral view and a schematic cross-sectional view of a known lead part formed by a drum body;

FIG. 38 is a schematic cross-sectional view of a known sealed battery in a state where an electrode body is contained in a battery case and welded to a sealing body by way of a lead part as shown in FIGS. 37A, 37B and 37C;

FIG. 39 is a schematic cross-sectional view of a known sealed battery having a bent current collecting lead;

FIG. 40 is a schematic cross-sectional view of a known sealed battery having a current collecting lead with a short-circuited electric conduction channel formed therein in a state where a sealing part is pressed;

FIG. 41 is a schematic perspective view of a known sealed battery in a state where a current collecting lead with a short-circuited electric conduction channel formed therein is welded to an electrode body;

FIGS. 42A and 42B are a schematic top view and a schematic lateral view of a known current collecting lead where a short-circuited electric conduction channel is formed;

FIG. 43 is a schematic cross-sectional view of a principal part of a known nickel-cadmium battery where a current collecting lead plate and a sealing body are welded at a contact area thereof after sealing to produce a welded area; and

FIG. 44 is a schematic illustration of an upper current collecting plate (positive electrode current collecting plate) that is used for the purpose of the present invention (Example 1 etc.).

### EXPLANATION OF REFERENCE SYMBOLS

20: lead having top part and lateral wall part where slits are formed
20-1: top part
20-2: lateral wall part of lead of (20)
20-3: welding projection of top part
20-4: slit of lateral wall part and flange portion
20-5: hole of top part
20-6: slit of top part
20-7: welding projection of lateral wall part of lead of (20)
30: flange portion
30-1: welding projection of flange portion
21: lead having frame part and lateral wall part where slits are formed
21-1: frame part 21-2: lateral wall part of lead of (21)
21-3: welding projection of frame part
21-4: slit of lateral wall part and bottom
21-5: slit of frame part
21-6: welding projection of lateral wall part of lead of (21)
31: bottom
31-1: welding projection of bottom
2: upper current collecting plate (positive electrode current collecting plate)
2-1: welding spot of lead in upper current collecting plate
2-2: slit in upper current collecting plate
2-3: ridge of upper current collecting plate (to be engaged with electrode)
50: lid
51: position on inner surface of 11d corresponding to end of cap
60: container
70: electrode assembly
80: cap
90: valve body
100: lower current collecting plate (negative electrode current collecting plate)

### BEST MODE FOR CARRYING OUT THE INVENTION

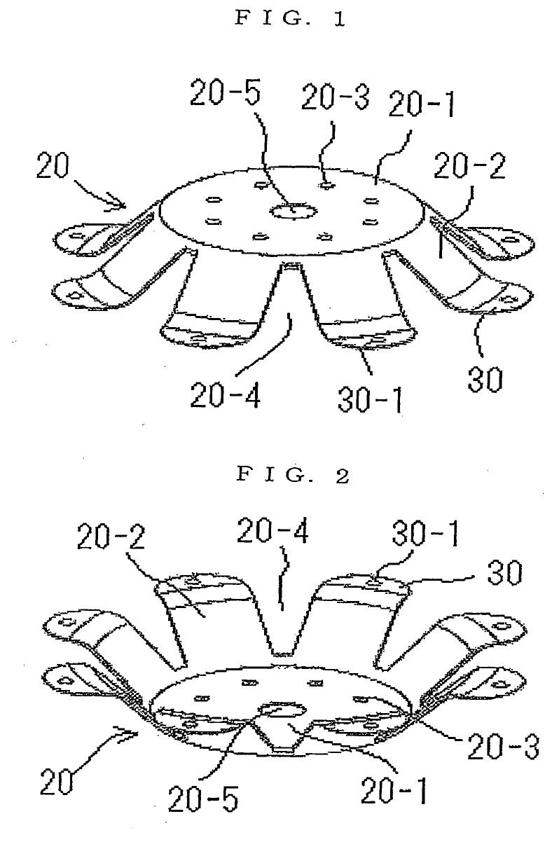

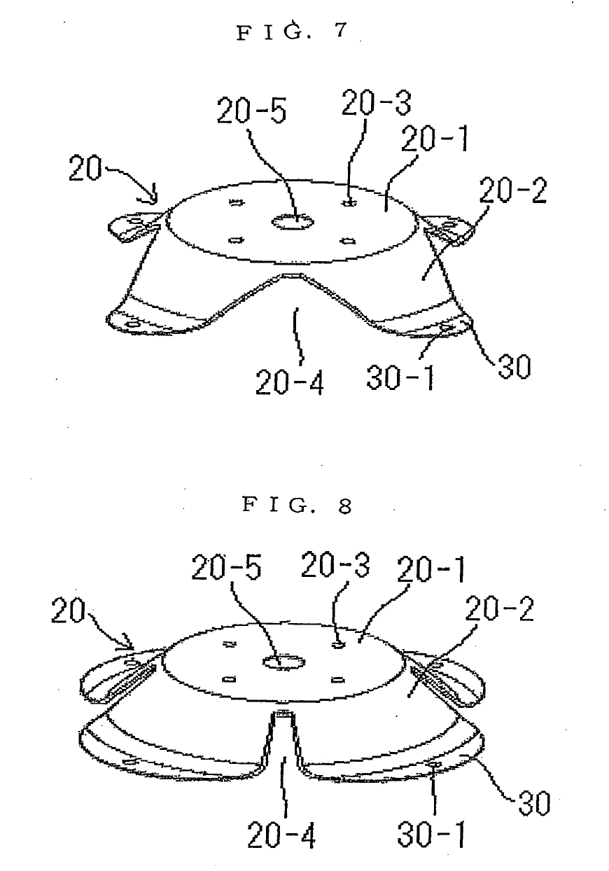

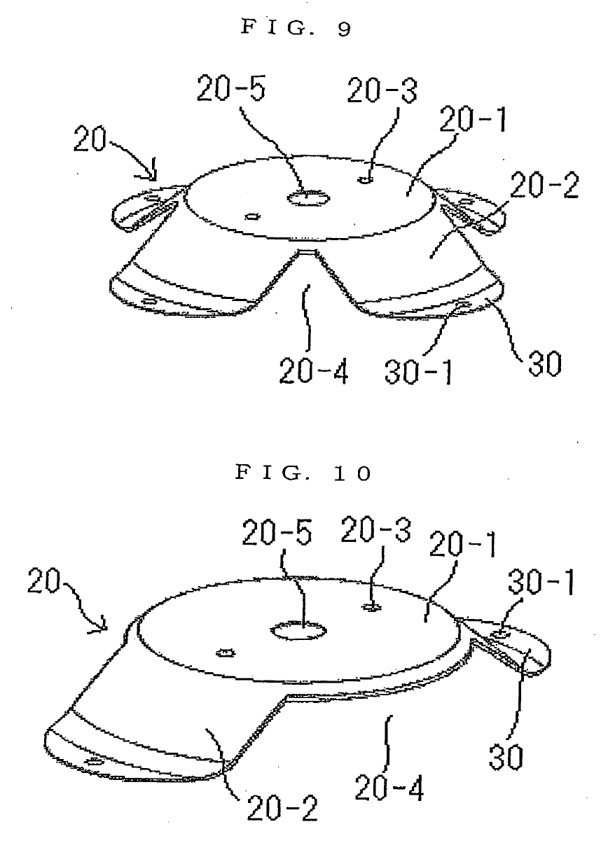

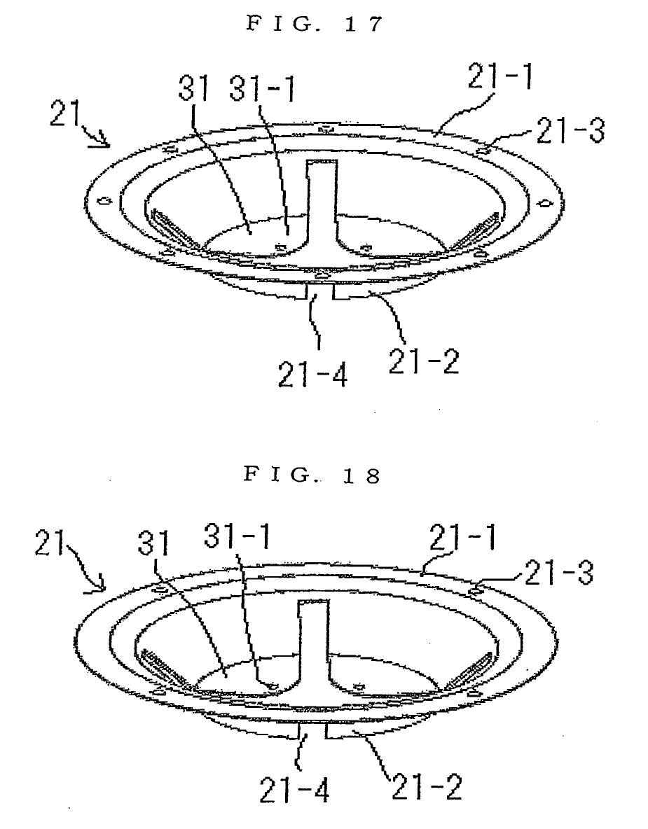

The inventors of the present invention analyzes the resistance components of sealed batteries to find out that the resistance of the lead takes a large part of the overall internal resistance of sealed battery. On the basis of the finding, the inventors of the present invention looked into possible reduction of the distance between the lid and the upper current collecting plate connected by a lead to find out that the lid and the upper current collecting plate can be connected with minimal resistance by using a lead having a structure as shown in any of FIGS. 1 through 29 if compared with a lead having a structure as shown in FIG. 34, 37 or 42.

FIGS. 1 through 22 illustrate the profiles of leads that can be used in a sealed battery according to the present invention.

Firstly, a lead “having a plate-shaped top part and a lateral wall part extending obliquely downwardly from the outer periphery of the top part so as to expand, slits being formed in the lateral wall part to extend longitudinally from the lower end thereof and at circumferential intervals” to be used in a sealed battery according to the present invention will be described by referring to FIGS. 1 through 12 (FIG. 2 is an inverted view of FIG. 1).

In FIGS. 1 through 12, a lead (20) is formed by subjecting an Ni or FeNi (nickel-plated steel) plate having a thickness of 0.2 to 0.4 mm to a press process. In the illustrated instances, a 0.3 mm-thick nickel plate is firstly subjected to a punch or wire cut process to produce slits (20-4) and holes (20-5) and subsequently to a press process. The maximum diameter of the lead (20) is about 17 mm for the sub C size and about 24 mm for the D size and the maximum height is about 2 to 3 mm for the sub C size and about 3 mm for the D size.

While the top part (20-1) of the lead is made to show a substantially disk-like profile as a result of a press process in FIGS. 1 through 12, the top part does not necessarily have to show a circular contour and may alternatively show a polygonal contour, for instance.

In FIGS. 1 through 11, the lead (20) has a flange portion (30) extending from the outer periphery of the lower end of the lateral wall part (20-2) and both the lateral wall part (20-2) and the flange portion (30) are provided with slits (20-4) that extend longitudinally from the lower end at circumferential intervals.

However, the lead (20-1) may not necessarily have to have a flange portion (30). Then, only the lateral wall part (20-2) is provided with slits (20-4).

Preferably, two or more than two slits are provided and arranged at circumferential and regular intervals.

Thus, with the above-described arrangement, when the lid and the upper current collecting plate are pressurized, the lead portions put between the slits (20-4) of the lateral wall part (20-2) or of the lateral wall part (20-2) and the flange portion (30) are bent to expand outwardly so as to absorb the height and maintain appropriate contact point pressure (pressure at contact points).

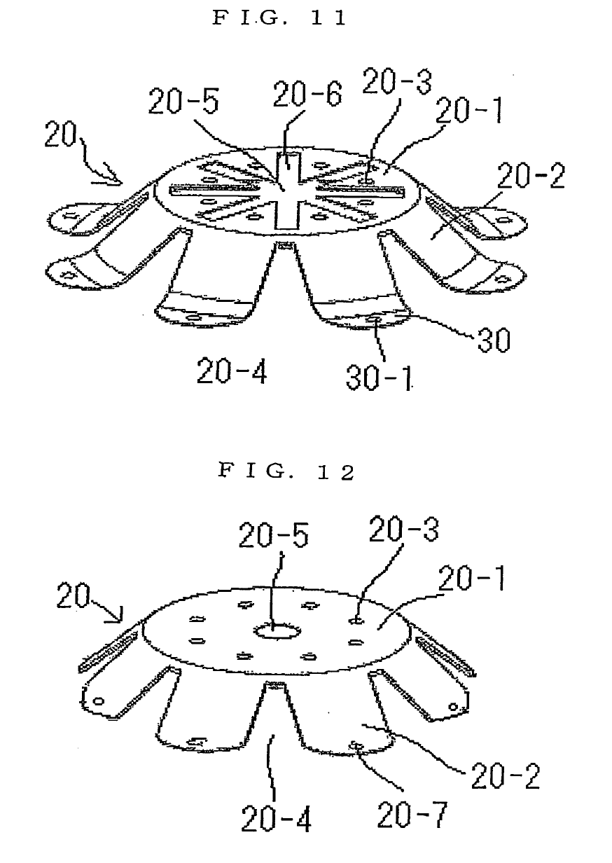

The top part (20-1) of the lead is welded to the lid by resistance welding in advance in the first welding step. While either series resistance welding or direct resistance welding may be used, the top part (20-1) is preferably also provided with slits (20-6) as shown in FIGS. 6 and 11 in order to reduce the reactive current and make the welding reliable when series resistance welding is employed.

Appropriate contact point pressure, which may vary as a function of the welding current, is required when welding the lead and the upper current collecting plate at contact points. When a large electric current is used, heat can be excessively generated and weld contact points can splash out because of a high contact resistance that appears at the time of passing a electric current unless the contact point pressure is sufficiently high. However, since the contact point resistance is low from the beginning, heat is generated only insufficiently to make it impossible to produce a firmly welded condition of the lead and the upper current collecting plate by a large electric current when the contact pressure is too high.

When the electric current is too small, on the other hand, generated heat is too small to weld the contact points unless the contact pressure and the contact resistance are made low and high respectively. Thus, the welding process can hardly be controllable and welding variances can take place when the electric current is small.

Therefore, to maintain the contact point pressure, the resistance of the welding contact points within a certain range and further the electric current within a certain range are very important to welding.

The welding projections at the welding spots of the lead and the upper current collecting plate may be such as the projections (30-1) shown in FIGS. 1 through 11 that are arranged in the areas of the flange portion (30) put between slits (20-4) or, when no flange is provided, such as the projections (20-7) shown in FIG. 12 that are arranged at the lower end of the areas of the lateral wall part (20-2) put between slits (20-4).

The projections (20-3) at the top part (20-1) preferably have a diameter between 0.5 and 1.0 mm and a height of not less than 0.5 mm to realize a good projection welding. The number of projections is preferably not less than two for the purpose of reducing the electric resistance of the points welded.

The projection (20-7) at the lower end of the lateral wall part (20-2) or the projection (30-1) at the flange portion (30) is preferably made to show a diameter between 0.5 and 1.0 mm and a height of not less than 0.5 mm by way of a press process to realize a good projection welding because the welding spots are made thinner than the lateral wall part. The number of projections is preferably not less than two for the purpose of making the welding reliable and more preferably not less than four for the purpose of reducing the electric resistance of the points welded. The D size batteries of the examples, which will be described in greater detail hereinafter, can provide an area where eight to sixteen points welded can be formed as shown in FIGS. 1 through 4, 11 and 12. In the case of sub C size batteries, it is only possible to form about four projections that operate as points welded because of a limited battery diameter and hence a small maximum diameter of the lead, although it is desirable to provide as many points welded as possible in order to reduce the total welding spot resistance.

Now, the sequence of operation of welding the lid and the upper current collecting plate by using a lead (20) illustrated in any of FIGS. 1 through 12 will be described below in detail.

The sequence of operation and the arrangement as described below can reliably weld the lid and the upper current collecting plate and reduce the electric resistance.

The top part (20-1) of the lead is welded to the inner surface side of the lid for closing the container of the sealed battery in advance (1st welding step).

Then, an electrode assembly bonded to an upper current collecting plate is contained in a container with the upper current collecting plate located at the open end side of the container and electrolyte is injected into the container. Subsequently, the lid is placed on the upper current collecting plate of the electrode assembly in such a way that the lower end of the lateral wall part (20-2) of the lead contacts the upper current collecting plate and the container is air tightly sealed. Thereafter, pressure of a certain level is applied to the lower end (projections) of the lead and the upper current collecting plate to adjust the height and the lead that is already welded to the lid and the upper current collecting plate are welded together by passing a welding electric current between the positive electrode terminal and the negative electrode terminal of the sealed battery (2nd welding step).

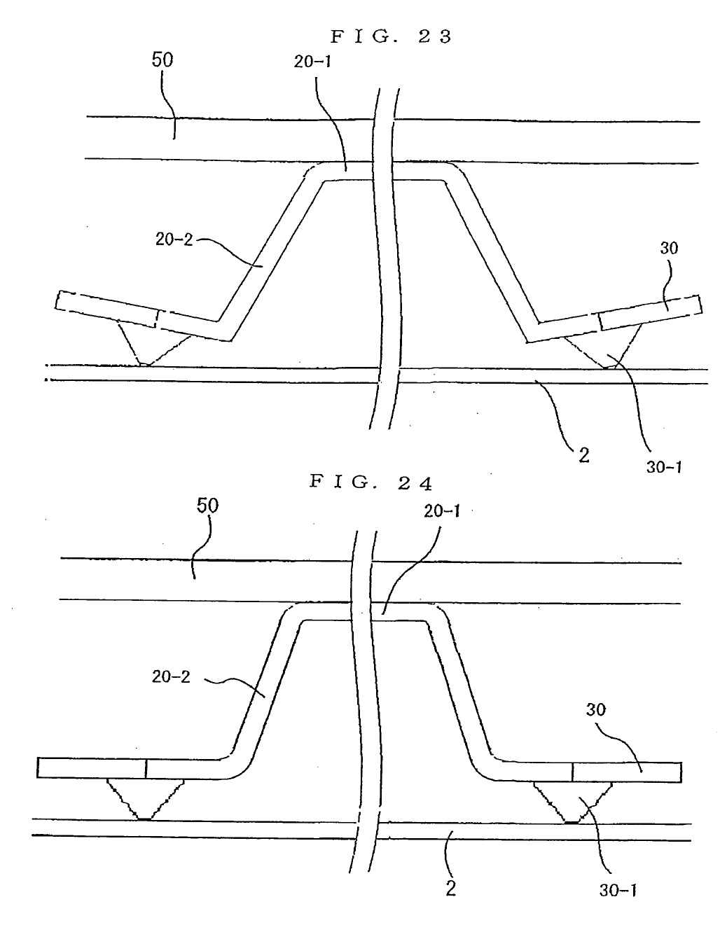

Examples of absorbing the vertical positional displacement of the electrode assembly when placing the lead that is already welded to the lid on the upper current collecting plate (2) and welding the lead (20) to the upper current collecting plate (2) will be described below by referring to FIGS. 23 through 25.

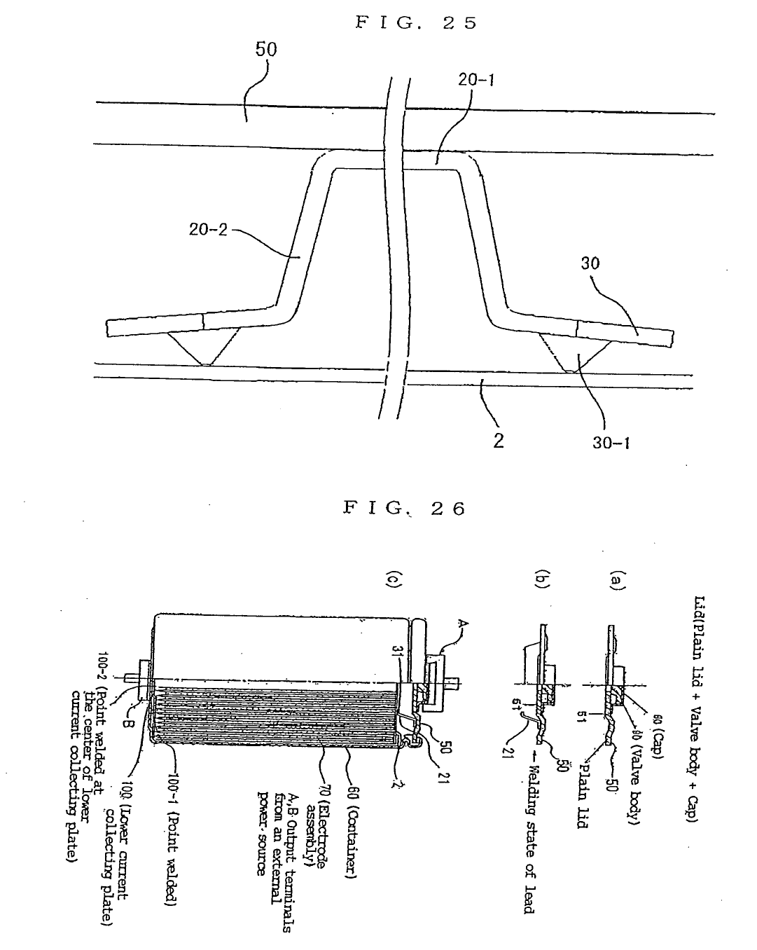

Of FIGS. 23 through 25, FIG. 23 illustrates an instance where the height of electrode assembly is large and FIG. 24 illustrates an instance where the height of electrode assembly is standard, whereas FIG. 25 illustrates an instance where the height of electrode assembly is small.

As clearly seen from the drawings, if the height of the electrode assembly shows variance, the resiliency of the lead is enhanced due to the spring effect of the flexible lateral wall part (20-2) and the flange portion (30) produced by the lead portions put between the slits (20-4) of the lateral wall part (20-2) and the flange portion (30) that are adapted to be bent outwardly to expand so that the vertical positional displacement of the electrode assembly can be absorbed. Thus, the upper current collecting plate (2) and the lead (20) can be welded together easily and reliably by applying appropriate pressure.

Note that it is not preferable to weld the upper current collecting plate and the lead in a released condition (before the height is adjusted by compression) like the prior art because the lead is required to have a wide margin for compression in terms of both length and width.

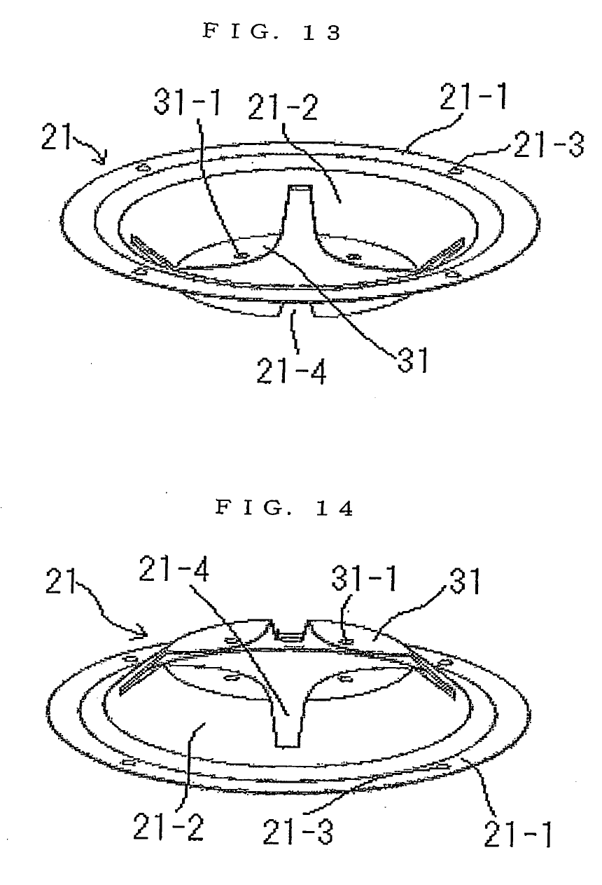

Now, a lead “having a plate-shaped frame part and a lateral wall part extending obliquely downwardly from the inner periphery of the frame part so as to contract, slits being formed in the lateral wall part to extend longitudinally from the lower end thereof and at circumferential intervals” to be used in a sealed battery according to the present invention will be described by referring to FIGS. 13 through 22 (FIG. 14 is an inverted view of FIG. 13).

In FIGS. 13 through 22, a lead (21) is formed by subjecting an Ni or FeNi (nickel-plated steel) plate having a thickness of 0.2 to 0.4 mm to a press process. In the illustrated instances, a 0.3 mm-thick nickel plate is firstly subjected to a punch or wire cut process to produce slits (21-4) and subsequently to a press process. The maximum diameter of the lead (21) is about 17 ma for the sub C size and about 24 mm for the D size and the maximum height is about 2 to 3 mm for the sub C size and about 3 mm for the D size.

While the frame part (21-1) of the lead is made to show a substantially disk-like profile as a result of a press process in FIGS. 13 through 22, the frame part does not necessarily have to show a circular contour and may alternatively show a polygonal contour, for instance.

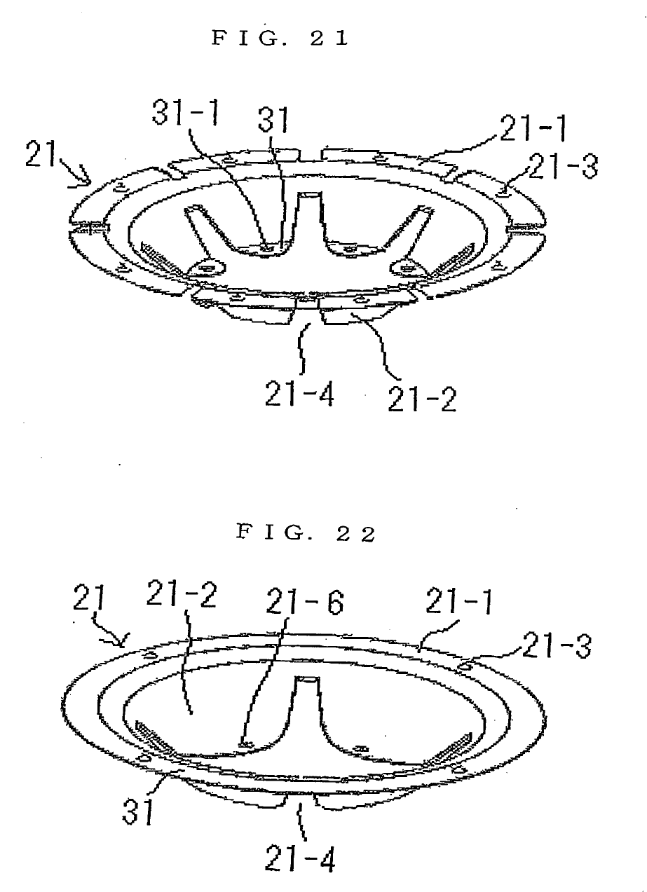

The frame part (21-1) of the lead is welded to the lid by resistance welding in advance in the first welding step. While either series resistance welding or direct resistance welding may be used, the frame part (21-1) is preferably also provided with slits (21-5) as shown in FIG. 21 in order to reduce the reactive current and make the welding reliable when series resistance welding is employed.

However, since the maximum diameter of a lead of the above-described type can be reduced with ease, it can suitably be used for a battery having a small diameter such as an A size battery. Then, the area to be held in contact with a welding head is also reduced. Therefore, it is necessary to employ direct welding because the lead is not suitable for series welding. If such is the case, the frame part (21-1) is preferably not provided with slits as shown in FIGS. 13 through 20 and 22.

In FIGS. 13 through 21, the lead has a bottom (31-1) extending from the inner periphery of the lower end of the lateral wall part (21-2) and both the lateral wall part (21-2) and a bottom (31) are provided with slits (21-4) that extend longitudinally from the lower end at circumferential intervals.

However, the lead (21) may not necessarily have to have the bottom (31). Then, only the lateral wall part (21-2) is provided with slits (21-4).

Preferably, two or more than two slits are provided and arranged at circumferential and regular intervals.

Thus, with the above-described arrangement, when the lid and the upper current collecting plate are pressurized, the lead portions put between the slits (21-4) of the lateral wall part (21-2) or of the lateral wall part (21-2) and the bottom (31) are bent to contract inwardly so as to absorb the height and maintain appropriate contact point pressure (pressure at contact points).

The conditions under which the contact points of the lead (21) and the upper current collecting plate (2) are welded are same for the leads (21) shown in FIGS. 13 through 21 as for the leads (20) shown in FIGS. 1 through 12.

The welding projections at the welding spots of the lead and the upper current collecting plate may be such as the projections (31-1) shown in FIGS. 13 through 21 that are arranged in the areas of the bottom (31) put between slits (21-4) or, when no bottom is provided, such as the projections (21-5) shown in FIG. 22 that are arranged in the areas of the lateral wall part (21-2) put between slits (21-4).

The projections (21-3) at the frame part (21-1) preferably have a diameter between 0.5 and 1.0 mm and a height of not less than 0.5 mm to realize a good projection welding. The number of projections is preferably not less than two for the purpose of reducing the electric resistance of the points welded.

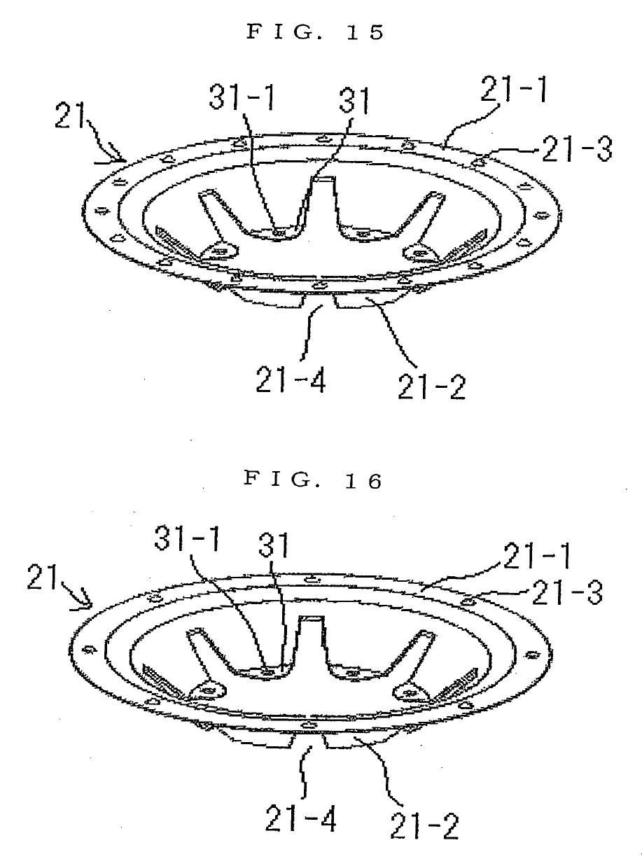

The projections (21-5) at the lateral wall part (21-2) or at the bottom (31) are preferably made to show a diameter between 0.5 and 1.0 mm and a height of not less than 0.5 mm to realize a good projection welding. As shown in FIGS. 13 through 22, the number of projections is preferably not less than two for the purpose of making the welding reliable and more preferably not less than four for the purpose of reducing the electric resistance of the points welded. The D size batteries of the examples, which will be described in greater detail hereinafter, can provide an area where eight to sixteen points welded can be formed as shown in FIGS. 15 and 16. In the case of sub C size batteries, it is only possible to form about four projections that operate as points welded because of a limited battery diameter and hence a small maximum diameter of the lead, although it is desirable to provide as many points welded as possible in order to reduce the total welding spot resistance.

FIGS. 26A through 26C illustrate a sealed battery assembled by welding lead (21), which may be any of the leads illustrated in FIGS. 13 through 21.

FIG. 26A is a schematic cross-sectional view of a lid (50) shown as an example. A cap (80) is put on a plain lid by way of a safety valve rubber (valve body) (90) at a central part of the plain lid.

FIG. 26B illustrates a lead (21) welded to a lid (50) in advance.

FIG. 26C illustrates a state where a lead (21) that is welded to a lid (50) in advance is further welded to the current collecting plate (2) of a sealed battery.

According to the present invention, the points welded of the lead (21) on the inner surface of the lid (50) are preferably located outside relative to the position (51) on the inner surface of the lid that corresponds to the end of the cap (80). Then, the contact point for leading out an electric current to the outside of the battery is preferably located outside relative to the end of the cap on the upper surface of the lid because the flow path of the electric current is minimized to reduce the internal resistance and maximize the output power density.

However, the lead cannot have a sufficient length in batteries having a diameter smaller than D size batteries such as A and AA size batteries and hence the welding points of the lead (21) or (20) may have to be located inside relative to the position (51) on the inner surface of the lid that corresponds to the end of the cap (80).

If such is the case, however, the flow path of the electric current between the points welded on the inner surface of the lid and those of the upper current collecting plate is very short when a lead according to the present invention is employed so that the electric resistance is minimized as a result of the welding operation. Thus, the present invention can provide a high performance battery of a low resistance level and a high output level.

Now, the sequence of operation of welding the lid and the upper current collecting plate (2) by using a lead (21) illustrated in any of FIGS. 13 through 22 will be described below in detail by referring to FIG. 26.

The sequence of operation and the arrangement as described below can reliably weld the lid and the upper current collecting plate and reduce the electric resistance.

The frame part (21-1) of the lead (21) is welded to the inner surface side of the lid (50) for closing the container of the sealed battery in advance (1st welding step).

Then, an electrode assembly (70) bonded to an upper current collecting plate (2) is contained in a container (60) with the upper current collecting plate (2) located at the open end side of the container and electrolyte is injected into the container (60). Subsequently, the lid is placed on the upper current collecting plate (2) of the electrode assembly (70) in such a way that the lower end of the lateral wall part (21-2) of the lead (21) contacts the upper current collecting plate (2) and the container (60) is airtightly sealed. Thereafter, pressure of a certain level is applied to the lower end (projections) of the lead (21) and the upper current collecting plate (2) to adjust the height and the lead (21) that is already welded to the lid (50) and the upper current collecting plate (2) are welded together by passing a welding electric current between the positive electrode terminal and the negative electrode terminal of the sealed battery (2nd welding step).

The vertical positional displacement of the electrode assembly (70) can be absorbed when putting the lead (21) that is already welded to the lid on the upper current collecting plate (2) and welding the lead (21) to the upper current collecting plate (2) in the second welding step.

In the case of leads (21) illustrated in FIGS. 13 through 21, if the height of the electrode assembly shows variance, the resiliency of the lead is enhanced due to the spring effect of the flexible lateral wall part (21-2) and the bottom (31) produced by the lead portions put between the slits (21-4) of the lateral wall part (21-2) and the bottom (31) that are adapted to be bent inwardly to contract so that the vertical positional displacement can be absorbed. Thus, the upper current collecting plate (2) and the lead (21) can be welded together easily and reliably by applying appropriate pressure.

Note that it is not preferable to weld the upper current collecting plate and the lead in a released condition (before the height is adjusted by compression) like the prior art because the lead is required to have a wide margin for compression in terms of both length and width.

While the above-described embodiments of the present invention require two welding steps, the lid and the lead are welded together in advance in the first welding step. Then, a sealed battery having a current collecting structure that shows a minimized electric resistance is realized because it is only in the second welding step to flow a welding current by way of a sealed battery after injecting electrolyte and hermetically sealing the container, using a lead (20) or (21) as shown in any of FIGS. 1 through 22.

The welding contact points of the upper current collecting plate (positive electrode current collecting plate) and the lead in the sealed battery can make the welding operation a difficult one when they are covered by an oxide coat. Therefore, they are preferably made of a metal that can hardly be oxidized or plated. Nickel hardly corrodes in alkaline electrolyte and can be welded with ease. Therefore, the contact points of the components on the electric current flow paths are preferably made of nickel.

When the sealed battery is operated for charging and discharging after the injection of electrolyte, the surface of the positive electrode current collecting plate and that of the lead can be oxidized by the positive electrode potential to make the welding unstable depending on the conditions of charging and discharging. Therefore, the positive electrode current collecting plate and the lead are welded together after injecting electrolyte and before charging the battery for the first time, which is an operation that involves a change in the positive electrode potential.

According to the present invention, a large alternating pulse current is made to flow between the positive and negative electrodes in a short time when welding the positive electrode current collecting plate and the lead. The applied electricity is stored in the electrostatic capacity of the positive electrode plate and the negative electrode plate to prevent the electrolyte from being decomposed to generate gas as a result of electrolysis, which gas can leak to the outside of the battery. In other words, a large electric current and a large quantity of electricity can be used to be passed without damaging the battery when the electrostatic capacitance is large.

The expression of electrostatic capacity as used herein refers to the electric capacity for receiving electricity without causing the internal pressure of the battery that is produced by the gas generated as a result of decomposition of the electrolyte of the battery to exceed the valve opening pressure of the battery. Strictly speaking, the electrostatic capacity includes the electric capacity accompanying the charging/discharging reaction of the battery and the electric capacity due to the gas generating reaction in addition to the electric double layer capacity of the positive electrode plate and the negative electrode plate.

Since the electrostatic capacity of the positive electrode plate and the negative electrode plate is believed to be closely related to the discharging capacity of the electrode plates, the electric current value to be passed and the quantity of electricity that is made to flow in one direction for a single cycle of passing a electric current (which can be replaced by the time of passing the electric current when the electric current value is constant) are preferably set to appropriate values by considering the relationship with the capacity of the electrode plates. According to the present invention, the scope of the electric current to be passed is set per unit discharging capacity, and then the scope of the time of applying the electric current is set, whereby the positive electrode current collecting plate and the lead can be bonded well by welding without damaging the battery if an electric current is made to flow between the positive electrode and the negative electrode.

More specifically, when the number of points welded is between four and sixteen, the electric current to be passed per unit discharging capacity is defined to be between 0.4 and 0.8 kA/Ah and the time of passing the current is defined to be between 3 and 7 msec. The electric current is preferably ½ of the above value when the number of points welded is not greater than two. Note that the discharging capacity of the positive electrode and that of the negative electrode of a battery are not necessarily equal to each other. In the case of alkaline storage batteries including nickel-hydrogen storage batteries and nickel-cadmium storage batteries, the discharging capacity is smaller at the positive electrode than at the negative electrode. The electric current to be passed per unit discharging capacity is defined by referring to the smaller discharging capacity of the positive electrode for such a battery. The magnitude of the flowing electric current is not necessarily constant relative to time. The expression of the magnitude of the flowing electric current as used herein refers to the average value of flowing electric current in the time of passing the current.

As pointed out above, according to the present invention, no electrolysis takes place and the welding operation proceeds well if a large electric current is made to flow between the positive electrode and the negative electrode when the electrostatic capacity is large.

In other words, according to the present invention, no electrolysis takes place and the welding operation proceeds well if a large electric current is made to flow between the positive electrode and the negative electrode when the electric double layer capacity included in the electrostatic capacity is large. Take, for instance, a nickel-hydrogen storage battery. The electric double layer capacity tends to be smaller at the negative electrode plate than at the positive electrode plate probably because the specific surface area of the hydrogen absorbing alloy powder of the negative electrode is small. In view of this fact, the hydrogen absorbing alloy powder is preferably immersed in a hot and weakly acidic aqueous solution such as an NaOH aqueous solution or an acetic acid-sodium acetate aqueous solution before it is put into the battery in order to raise the electric double layer capacity of the negative electrode plate.

A sealed battery according to the present invention shows a small internal resistance of the battery and its adaptability to high speed charging can be enhanced. Therefore, both the positive electrode and the negative electrode are preferably made to be highly adaptable to charging.

Take again, for instance, a nickel-hydrogen storage battery. A mixture of nickel hydroxide, zinc hydroxide and cobalt hydroxide is used for the positive electrode, which is also referred to as nickel electrode. Preferably, a complex hydroxide containing, as a main ingredient, nickel hydroxide obtained by coprecipitating nickel hydroxide, zinc hydroxide and cobalt hydroxide is used. Additionally, it is preferable to raise the oxygen overvoltage of the nickel electrode by adding one or more than one rare earth elements such as Y, Er and/or Yb to the nickel electrode in order to suppress generation of oxygen at the nickel electrode at the time of high speed charging.

Now, the present invention will be described further in greater detail by way of examples where cylindrical nickel-hydrogen batteries are prepared. However, the present invention is by no means limited to the examples.

### Example 1

### Preparation of Positive Electrode Plate

Ammonium sulfate and aqueous solution of caustic soda were added to aqueous solution prepared by dissolving nickel sulfate, zinc sulfate and cobalt sulfate to a predetermined ratio to produce an ammine complex. Caustic soda was dropped further, while fiercely stirring the reaction system and controlling the pH of the reaction system to 11 to 12, so as to synthesize globular high density nickel hydroxide particles that operate as core layer base material and show a ratio of nickel hydroxide:zinc hydroxide cobalt hydroxide of 88.45:5.12:1.1.

The high-density nickel hydroxide particles were put into alkaline aqueous solution whose pH was controlled to pH 10 to 13 by means of caustic soda. Then, aqueous solution containing cobalt sulfate and ammonium to predetermined respective concentrations was dropped into the above solution, while stirring the solution. During this operation, aqueous solution of caustic soda was dropped appropriately to maintain the pH of the reaction bath to the range between 11 and 12. The pH was maintained to the range between 11 and 12 for about an hour to form a surface layer of a mixture of hydroxides containing Co on the surfaces of the nickel hydroxide particles. The ratio of the surface layer of the mixture of hydroxides relative to the core layer base material particles (to be referred to simply as core layer hereinafter) was 4.0 wt %.

Then, 50 g of nickel hydroxide particles having a surface layer of the above mixture of hydroxides was put into aqueous solution of caustic soda of 30 wt % (10N) at 110° C. and the solution was agitated thoroughly. Subsequently, K₂S₂O₈ was added excessively to the equivalent weight of the cobalt hydroxide contained in the surface layer to make sure that oxygen gas is generated from the particle surfaces. The active substance particles were filtered, washed with water and dried.

Aqueous solution of carboxymethyl cellulose (CMC) was added to the above active substance particles to produce paste of the active substance particles: the CMC solute=99.5:0.5. Then, the paste was filled into a nickel porous body having a surface density of 450 g/m² (Nickel Cellmet #8: tradename, available from Sumitomo Electric Industries). The filled nickel porous body was then dried at 80° C., subsequently pressed and coated with polytetrafluoroethylene at the surface to produce a nickel positive electrode plate having a width of 47.5 mm (of which 1 mm was uncoated part), a length of 1,150 mm and a capacity of 6,500 mAh (6.5 Ah).

### (Preparation of Negative Electrode Plate)

A hydrogen absorbing alloy in the form of a powder having an average diameter of 30 μm and belonging to an AB₅ type rare earth element system whose composition is represented MMNi_{3.6}CO_{0.6}Al_{0.3}Mn_{0.35} was treated for hydrogen absorption and subsequently immersed into aqueous solution containing NaOH by 48 wt % at 20° C. and then at 100° C. for 4 hours.

Subsequently, the specimen was pressurized and filtered to separate the treatment solution and the alloy. Then, pure water was added to the alloy by the amount equal to the weight of the alloy and the mixture was exposed to an ultrasonic wave of 28 KHZ for 10 minutes. Then, the mixture was stirred gently, while pure water was injected from below the suspension layer that was being stirred and excessive water was allowed to flow out with the hydroxides of rare earth metals released from the alloy, thereby purging the released hydroxides. Then, the specimen was washed with water until the pH falls below 10 and then the remaining mixture was pressurized and filtered. Subsequently, the specimen was exposed to warm water at 80° C. to eliminate hydrogen. The warm water was pressurized and filtered and the specimen was washed with water once again. Then, the alloy was cooled to 25° C. and 4% hydrogen peroxide was added by the amount equal to the weight of the alloy, while stirring the mixture, to eliminate hydrogen and produce a hydrogen absorbing alloy to be used for the electrode.

The obtained alloy and a styrene butadiene copolymer was mixed to a ratio of 99.35:0.65 by solid weight and dispersed into water to form paste. Then, the paste was applied to a punched steel plate made of a nickel-plated iron plate by means of a blade coater and then dried at 80° C. Then, the coated steel plate was pressed to produce a hydrogen absorbing alloy negative electrode plate having a width of 47.5 mm, a length of 1,175 mm and a capacity of 11,000 mAh (11.0 Ah).

### (Preparation of Sealed Nickel-Hydrogen Battery)

The negative electrode plate, a sheet of unwoven textile of sulfonated polyproplylene having a thickness of 120 μm that serves as separator and the positive electrode plate were combined and wound to form a roll of electrode assembly. A disk-shaped upper current collecting plate (positive electrode current collecting plate) (2) formed by using a nickel-plated steel plate to show a half diameter of 14.5 mm and a thickness of 0.4 mm with a central through hole and eight 0.5 mm high ridges (to be engaged with the corresponding electrode) (running along four slits (2-2)) as shown in FIG. 44 was bonded to the end facet of the positive electrode substrate projecting from one of the opposite ends of the roll of the electrode assembly by resistance welding. A disk-shaped lower current collecting plate (negative electrode current collecting plate) also formed by using a 0.4 mm thick nickel-plated steel plate was bonded to the end facet of the negative electrode substrate projecting from the other end of the roll of the electrode assembly by resistance welding. A bottomed cylindrical container/can made of nickel-plated steel plate was brought in and the electrode assembly to which the current collecting plates were fitted was contained in the container/can with the positive electrode current collecting plate located at the open end side of the container/can and the negative electrode current collecting plate held in contact with the bottom of the container/can. Then, a central part of the negative electrode current collecting plate was bonded to the wall surface of the container/can by resistance welding. Subsequently, electrolyte, which was aqueous solution containing 6.8N KOH and 0.8N LiOH, was injected into the container/can by a predetermined quantity.

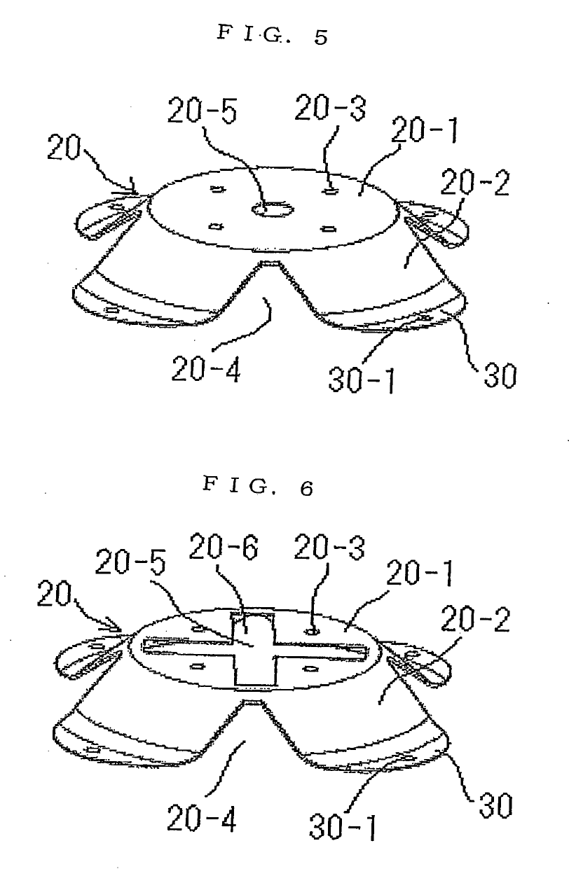

A lead (20) having a half diameter of 12 mm and a maximum height of 3 mm with four projections (20-3) arranged at the top part (20-1) and four projections (30-1) arranged at the flange portion (30) thereof as shown in FIG. 5 was prepared by subjecting a 0.4 mm-thick nickel plate to a press process.

Subsequently, the projections (20-3) of the top part (20-1) of the lead was brought into contact with the inner surface of a lid and bonded to it by direct spot welding.

A rubber valve (vent valve) and cap-shaped terminal were fitted to the outer surface of the lid. A ring-shaped gasket was fitted to the lid so as to surround the latter.

The lid was placed on the electrode assembly with the projections (30-1) of the flange portion (30) of the lead fitted to the lid held in contact with the positive electrode current collecting plate and the open end of the container was caulked to airtightly seal the battery. Then, the battery was compressed to adjust the total height of the battery. The angle of the flange portion (30) was so adjusted that the height between the lid and the positive electrode terminal was such that pushing force of 200 gf is applied to the contact area of each of the projections (30-1) of the flange portion (30) and the positive electrode current collecting plate (2) after the adjustment of the total height of the battery.

Note that the lid had a half diameter of 14.5 mm and the cap had a half diameter of 6.5 mm, while the crimping diameter of the gasket was 12.5 mm.

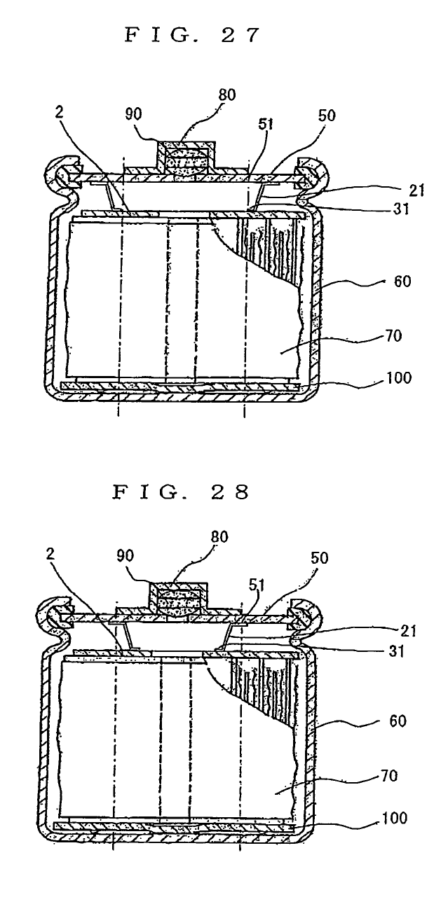

The welding output terminal of a resistance welder was brought to contact the cap (80) (positive electrode terminal) and the bottom surface (negative electrode terminal) of the container (60) and the conditions of applying a electric current were so set that a same electric current value and a same period of applying time were to be observed in both the charging and discharging directions. More specifically, the electric current value was set to 0.46 kA/Ah (3.0 kA) per 1 Ah capacity of the positive electrode (6.5 Ah) and the applying time was set to 4.0 msec for both the charging direction and the discharging direction as a cycle of alternating pulse current. Then, the welder was set to give two cycles and an alternating square pulse current was made to flow in order to weld the contact points of the flange portion (30) of the lead (20) to the upper surface of the positive electrode current collecting plate (2). It was made sure that the pressure of the generated gas is not high enough for opening the valve. A sealed nickel-hydrogen storage battery as shown in FIG. 29 where a lid (50) and a positive electrode current collecting plate (2) are connected by way of a lead was prepared in this way.

All the batteries of the Examples and the Comparative Examples of this specification had a weight of about 176 g.

### (Chemical Maturation and Measurement of Internal Resistance and Output Power Density)

The above-described sealed storage battery was left at ambient temperature of 25° C. for 12 hours. Subsequently, it was charged to 1,200 mAh by an electric current of 130 mA (0.02 ItA) and then by an electric current of 650 mA (0.1 ItA) for 10 hours. The battery was then discharged to 1 V, which was the cut voltage, by an electric current of 1,300 mA (0.2 ItA). Then, the battery was charged again for 16 hours by an electric current of 650 mA (0.1 ItA) and discharged to 1.0 V, or the cut voltage, by an electric current of 1,300 mA (0.2 ItA). The above charging and discharging cycle was repeated four times. After the completion of the discharge of the last cycle, the internal resistance of the battery was measured by means of an alternating current of 1 kHz.

The output power density was measured by using a battery in an atmosphere of 25° C. After charging for 5 hours by an electric current of 650 mA (0.1 ItA) from the end of a discharge and then the battery was discharged to 1V, or the cut voltage, by an electric current of 60 A for 12 seconds. The voltage of the battery at the 10th second was measured as the 10th second voltage for a 60 A discharge. Then, the battery was charged to compensate the discharge by 6 A and subsequently discharged by 90 A for 12 seconds. The voltage of the battery at the 10th second was measured as the 10th second voltage for a 90 A discharge. Then, the battery was charged to compensate the discharge by 6 A again and subsequently discharged by 120 A for 12 seconds. The voltage of the battery at the 10th second was measured as the 10th second voltage for a 120 A discharge. Likewise, the battery was charged to compensate the discharge by 6 A and subsequently discharged by 150 A for 12 seconds. The voltage of the battery at the 10th second was measured as the 10th second voltage for a 150 A discharge. Similarly, the battery was charged to compensate the discharge by 6 A and subsequently discharged by 180 A for 12 seconds. The voltage of the battery at the 10th second was measured as the 10th second voltage for a 180 A discharge.

The relationship between the 10th second voltages and the discharge currents was approximated to a line by a least square method. The voltage value observed when the electric current value was 0 A was expressed as E0 and the gradient of the line was expressed by RDC. Then, the output power density was determined at the time when the battery was discharged to a cut voltage of 0.8V at 25° C. by using the formula shown below.

output power density (W/kg)=(E0−0.8)/RDC×8/battery weight (kg).

### Comparative Example 1

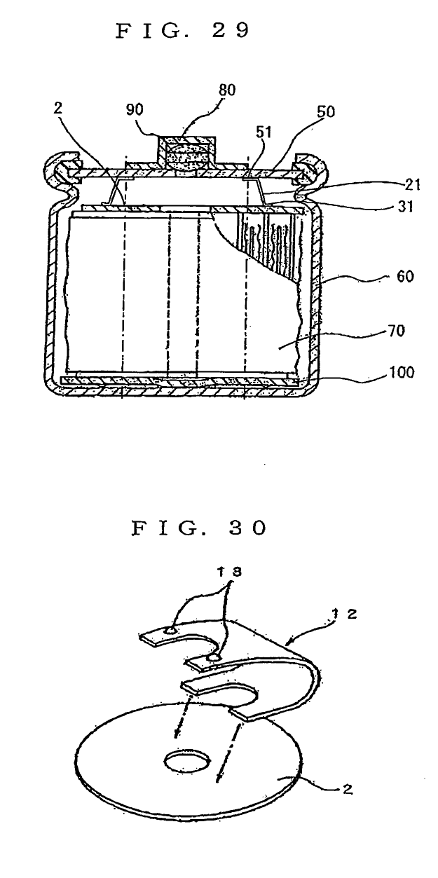

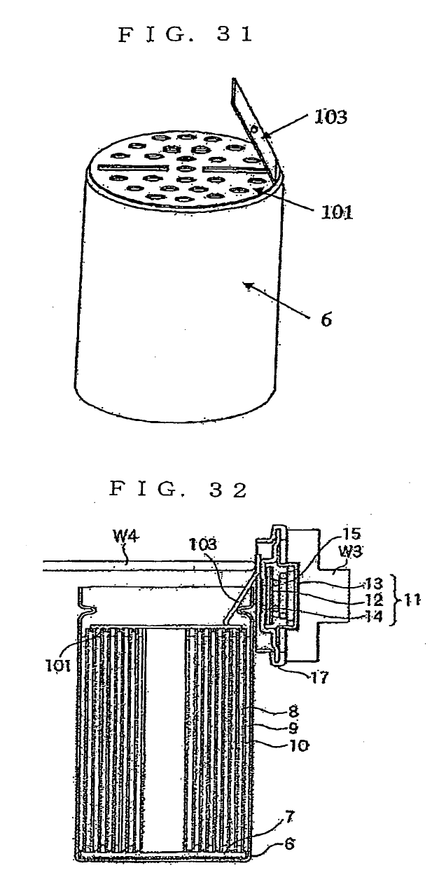

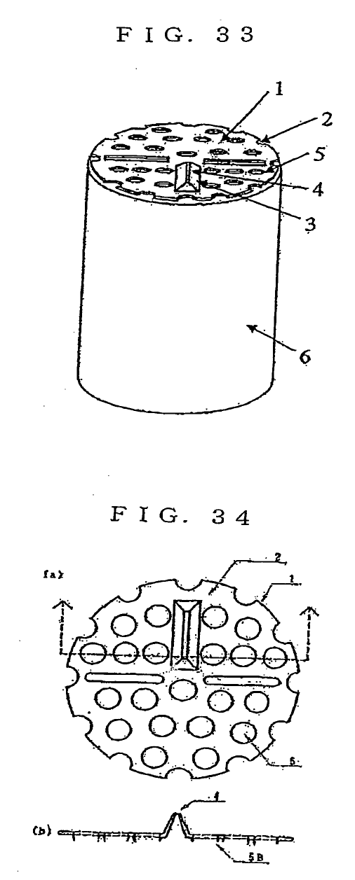

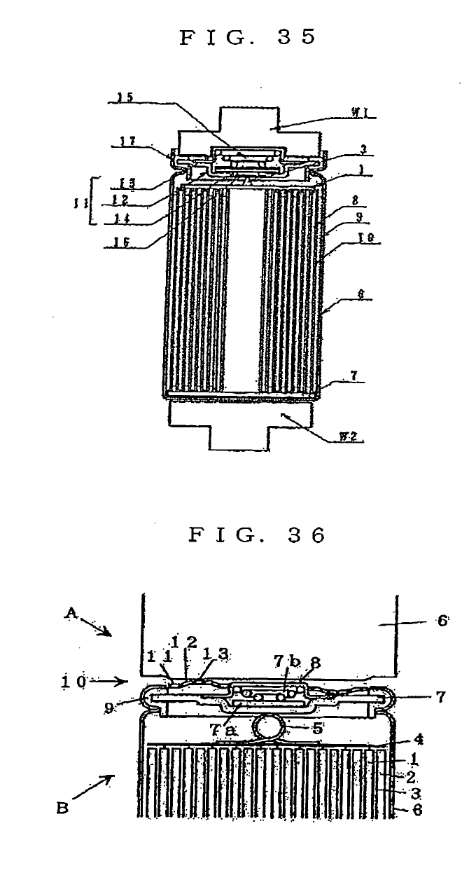

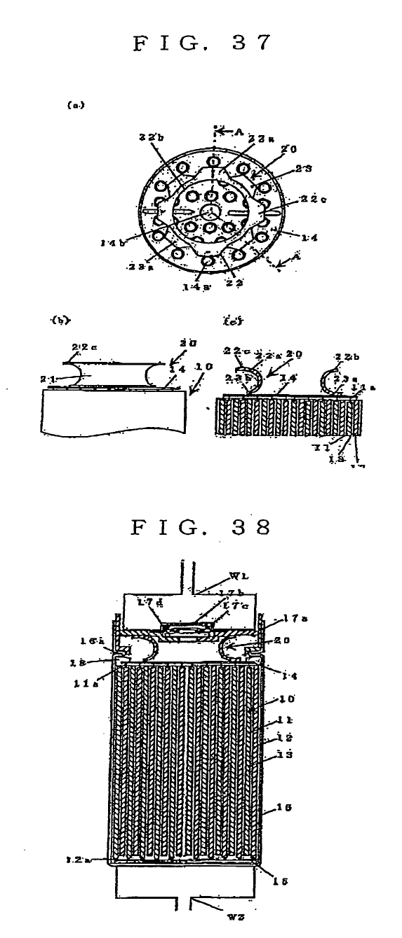

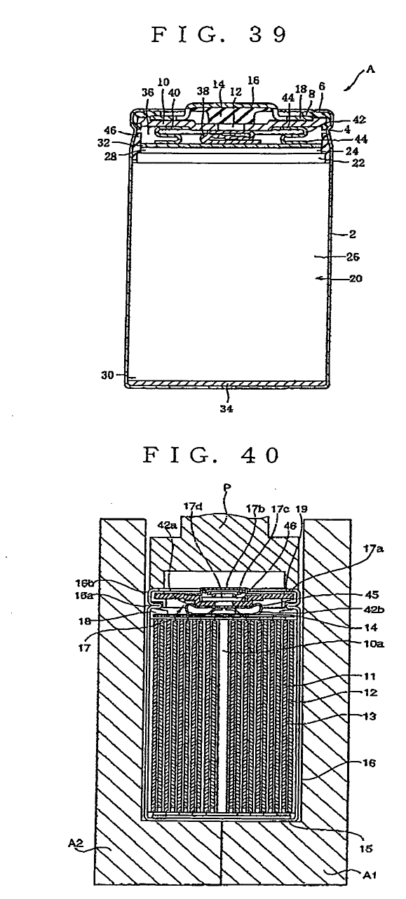

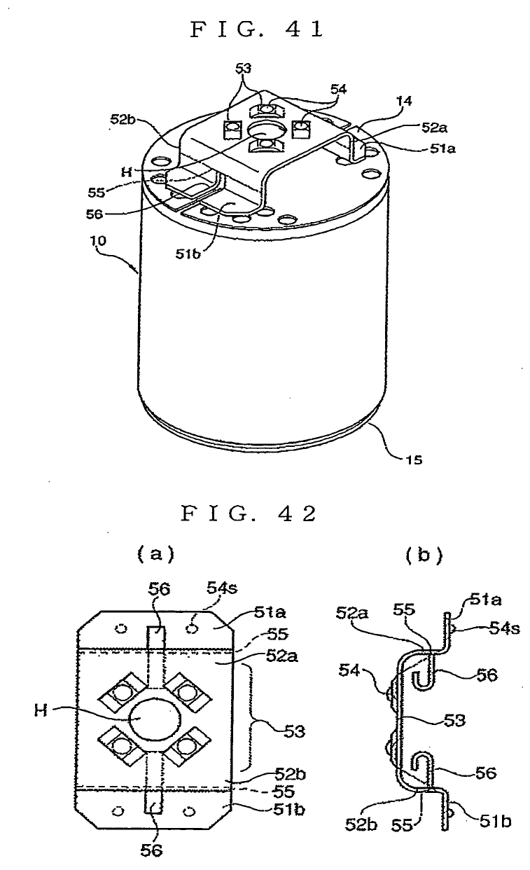

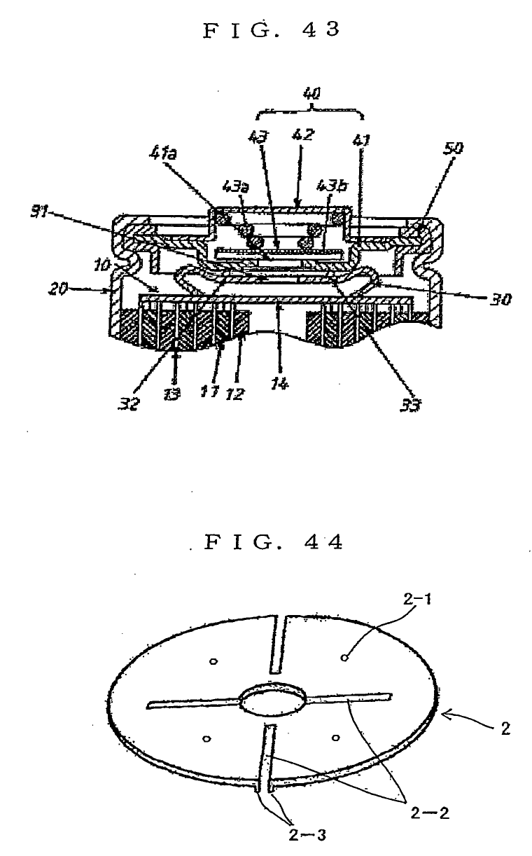

A sealed nickel-hydrogen storage battery was prepared as in Example 1 except that a conventional ribbon-shaped lead as shown in FIG. 30 was welded to the inner surface of the lid (50) and the upper surface of the upper current collecting plate (2) to connect them in advance for assembling the battery.

### Example 2

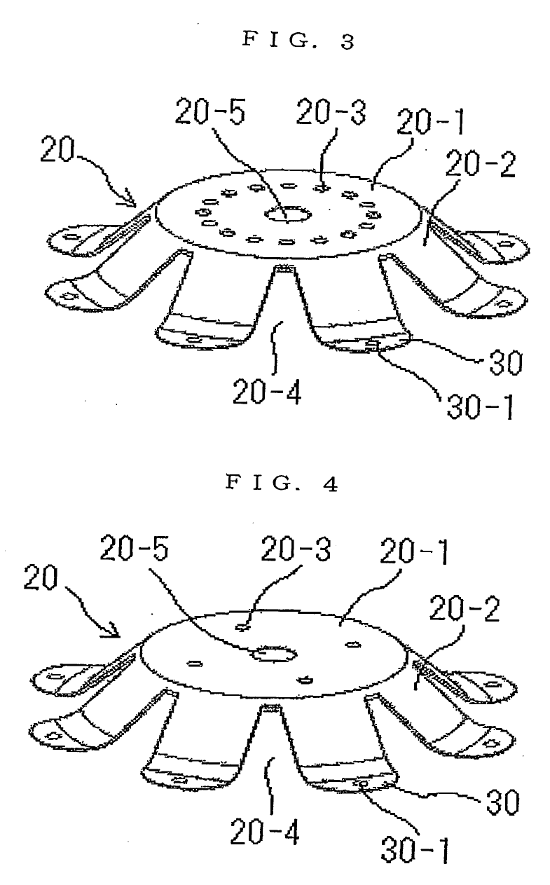

A sealed nickel-hydrogen storage battery as shown in FIG. 29 was prepared as in Example 1 except that a lead having 16 projections (20-3) at the top part (20-1) and 8 projections (30-1) at the flange portion (30) as shown in FIG. 3 was welded to the inner surface of the lid (50) and the upper surface of the upper current collecting plate (2) to connect them and a welding current of 3.6 KA was employed.

### Example 3

A sealed nickel-hydrogen storage battery as shown in FIG. 29 was prepared as in Example 1 except that a lead hating 8 projections (20-3) at the top part (20-1) and 8 projections (30-1) at the flange portion (30) as shown in FIG. 1 was welded to the inner surface of the lid (50) and the upper surface of the upper current collecting plate (2) to connect them and a welding current of 3.6 KA was employed.

### Example 4

A sealed nickel-hydrogen storage battery as shown in FIG. 29 was prepared as in Example 1 except that a lead having 2 projections (20-3) at the top part (20-1) and 2 projections (30-1) at the flange portion (30) as shown in FIG. 10 was welded to the inner surface of the lid (50) and the upper surface of the upper current collecting plate (2) to connect them and a welding current of 1.5 KA was employed.

### Comparative Example 2

A sealed nickel-hydrogen storage battery as shown in FIG. 29 was prepared as in Example 1 except that a lead having a single projection (20-3) at the top part (20-1) and a single projection (30-1) at the flange portion (30) was welded to the inner surface of the lid (50) and the upper surface of the upper current collecting plate (2) to connect them and a welding current of 0.7 KA was employed.

### Example 5

A sealed nickel-hydrogen storage battery as shown in FIG. 29 was prepared as in Example 1 except that the lead welded to the inner surface of the lid (50) and the upper surface of the upper current collecting plate (2) of Example 1 was replaced by a lead (20) having slits (20-6) at the top part (20-1) as shown in FIG. 11 and the lead (20) was welded to the lid (50) by series spot welding and that a welding current of 3.6 KA was employed.

### Example 6

A sealed nickel-hydrogen storage battery as shown in FIG. 28 was prepared as in Example 1 except that a lead having 4 projections (21-3) at the frame part (21-1) and 4 projections (31-1) at the bottom (31) as shown in FIG. 13 was welded to the inner surface of the lid (50) and the upper surface of the upper current collecting plate (2) to connect them.

### Example 7

A sealed nickel-hydrogen storage battery as shown in FIG. 28 was prepared as in Example 6 except that a lead having 16 projections (21-3) at the frame part (21-1) and 8 projections (31-1) at the bottom (31) as shown in FIG. 15 was welded to the inner surface of the lid (50) and the upper surface of the upper current collecting plate (2) to connect them and a welding current of 3.6 KA was employed.

### Example 8

A sealed nickel-hydrogen storage battery as shown in FIG. 28 was prepared as in Example 6 except that a lead having 8 projections (21-3) at the frame part (21-1) and 8 projections (31-1) at the bottom (31) as shown in FIG. 16 was welded to the inner surface of the lid (50) and the upper surface of the upper current collecting plate (2) to connect them and a welding current of 3.6 KA was employed.

### Example 9

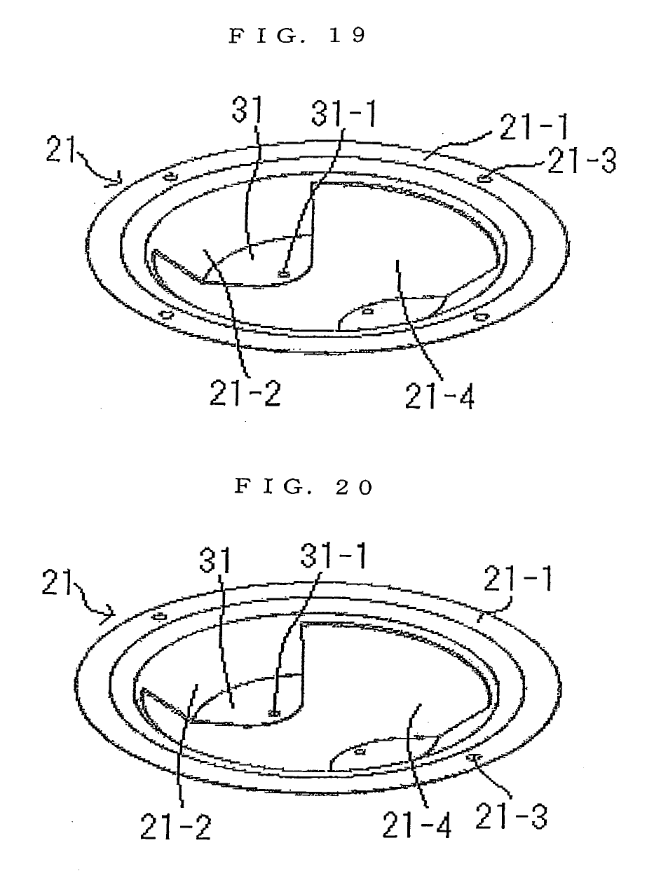

A sealed nickel-hydrogen storage battery as shown in FIG. 28 was prepared as in Example 6 except that a lead having 2 projections (21-3) at the frame part (21-1) and2 projections (31-1) at the bottom (31) as shown in FIG. 20 was welded to the inner surface of the lid (50) and the upper surface of the upper current collecting plate (2) to connect them and a welding current of 1.5 KA was employed.

### Comparative Example 3

A sealed nickel-hydrogen storage battery as shown in FIG. 28 was prepared as in Example 6 except that a lead having a single projection (21-3) at the frame part (21-1) and a single projection (31-1) at the bottom (31) was welded to the inner surface of the lid (50) and the upper surface of the upper current collecting plate (2) to connect them and a welding current of 0.7 KA was employed.

### Example 10

A sealed nickel-hydrogen storage battery as shown in FIG. 28 was prepared as in Example 6 except that the lead welded to the inner surface of the lid (50) and the upper surface of the upper current collecting plate (2) of Example 8 was replaced by a lead (21) having slits (21-5) at the frame part (21-1) as shown in FIG. 21 and the lead (21) was weldedto the lid (50) by series spot welding.

Table 1 below shows the internal resistances and the output power densities observed for the batteries prepared in Examples 1 through 10 and Comparative Examples 1 through 3.

TABLE 1

| | | number of points welded | | | |
|---|---|---|---|---|---|
| | | | lead - upper | internal | output power |
| | | lid - lead | current collecting plate | resistance | density |
| classification | lead plate profile | points welded | points welded | (mΩ) | W/kg |
| Example 1 | D hat type (no slit in top | 4 | 4 | 0.95 | 1480 |
| | part)/direct welding | | | | |
| Comparative | ribbon type lead plate | 2 | 2 | 1.50 | 1000 |
| Example 1 | | | | | |
| Example 2 | D hat type (no slit in top | 16 | 8 | 0.88 | 1560 |
| | part)/direct welding | | | | |
| Example 3 | D hat type (no slit in top | 8 | 8 | 0.92 | 1520 |
| | part)/direct welding | | | | |
| Example 4 | D hat type (no slit in top | 2 | 2 | 1.02 | 1410 |
| | part)/direct welding | | | | |
| Comparative | D hat type (no slit in top | 1 | 1 | 1.70 | 800 |
| Example 2 | part)/direct welding | | | | |
| Example 5 | D hat type (with slits in top | 8 | 8 | 0.92 | 1520 |
| | part)/series welding | | | | |
| Example 6 | D saucer type (no slit in frame | 4 | 4 | 0.95 | 1480 |
| | part)/direct welding | | | | |
| Example 7 | D saucer type (no slit in frame | 16 | 8 | 0.88 | 1560 |
| | part)/direct welding | | | | |
| Example 8 | D saucer type (no slit in frame | 8 | 8 | 0.92 | 1520 |
| | part)/direct welding | | | | |
| Example 9 | D saucer type (no slit in frame | 2 | 2 | 1.02 | 1410 |
| | part)/direct welding | | | | |
| Comparative | D saucer type (no slit in frame | 1 | 1 | 1.70 | 800 |
| Example 3 | part)/direct welding | | | | |
| Example 10 | D saucer type (with slits in frame | 8 | 8 | 0.92 | 1520 |
| | part)/series welding | | | | |

By Comparative Examples 1 through 5 and Comparative Example 1 in Table 1, it will be seen that a lead (20) having a plate-shaped top part (20-1) and a lateral wall part (20-2) extending obliquely downward from the outer periphery of the top part (20-1) so as to expand with slits (20-4) formed in the lateral wall part (20-2) and the flange portion (30) to extend longitudinally from the lower end thereof and at circumferential intervals can produce a battery that minimizes the internal resistance and provides an excellent power output.

It may be safe to assume that this is because the inter-points welded distance is short, the electric current flow channel has a large cross-sectional area and the lead resistance is small if compared with a conventional ribbon-shaped lead of Comparative Example 1.

An excellent power output can be realized when the number of welding spot of the lead (20) and that of the lid (50) is not less than two. The greater the number of points welded, the smaller the internal resistance and the greater the output power density. The number of points welded is preferably not less than six or eight.

Similarly, an excellent power output can be realized when the number of welding spot of the lead (20) and that of the upper current collecting plate (2) are not less than two. The greater the number of points welded, the smaller the internal resistance and the greater the output power density. The number of points welded is preferably not less than six or eight.

A single welding spot is not preferable because the internal resistance becomes large as in the case of Comparative Example 2.

It may be safe to assume that this is because the electric current flow channel is converged to a spot to make the electrode plate reaction uneven and raise the internal resistance.

When a lead having no slit at all in the lateral wall part was used and the upper current collecting plate and the lead was welded as in Example 1, a uniform contact pressure could not absorb the variance of the height of the electrode assembly if the electrode assembly has a large height and the lead was deformed. It may be for this reason that the lead and the upper current collecting plate were welded unevenly to produce a battery that could only provide a low power output.

Therefore, preferably the slits (20-4) formed in the lateral wall part (20-2) and the flange portion (30) extend longitudinally from the lower end thereof and at circumferential intervals and the lead parts in the lateral wall parts (20-2) and the flange portion (30) put between the slits (20-4) are structurally adapted to be bent outward so as to expand.

By Comparative Examples 6 through 10 and Comparative Example 1 in Table 1, it will be seen that a lead (21) having a plate-shaped frame part (21-1) and a lateral wall part (21-2) extending obliquely downward from the inner periphery of the frame part (21-1) so as to contract with slits (21-4) formed in the lateral wall part (21-2) and the bottom (31) to extend longitudinally from the lower end thereof and at circumferential intervals can produce a battery that minimizes the internal resistance and provides an excellent power output.

It may be safe to assume that this is because the inter-points welded distance is short, the electric current flow channel has a large cross-sectional area and the lead resistance is small if compared with a conventional ribbon-shaped lead of Comparative Example 1.

An excellent power output can be realized when the number of welding spot of the lead (21) and that of the lid (50) is not less than two. The greater the number of points welded, the smaller the internal resistance and the greater the output power density.

Similarly, an excellent power output can be realized when the number of welding spot of the lead (21) and that of the upper current collecting plate (2) are not less than two. The greater the number of points welded, the smaller the internal resistance and the greater the output power density.

A single welding spot is not preferable because the internal resistance becomes large as in the case of Comparative Example 3.

It may be safe to assume that this is because the electric current flow channel is converged to a spot to make the electrode plate reaction uneven and raise the internal resistance.

When a lead having no slit at all in the lateral wall part was used and the upper current collecting plate and the lead was welded as in Example 6, a uniform contact pressure could not absorb the variance of the height of the electrode assembly if the electrode assembly has a large height and the lead was deformed. It may be for this reason that the lead and the upper current collecting plate were welded unevenly to produce a battery that could only provide a low power output.

Therefore, preferably the slits (21-4) formed in the lateral wall part (21-2) and the bottom (31) extend longitudinally from the lower end thereof and at circumferential intervals and the lead parts in the lateral wall parts (21-2) and the bottom (31) put between the slits (21-4) are structurally adapted to be bent inward so as to contract.

It is clear from Examples 1 through 10 that the lateral wall part (20-2) or (21-2) of the lead (20) or (21), whichever appropriate, preferably has a ring-shaped profile so that an electric current can be taken out uniformly from the upper current collecting plate (2). More preferably, the slits (20-4) or (21-4) extending from the circle defined by the lower end of the lead are arranged at regular intervals so that external force may be uniformly applied to the lead.

When slits are formed to run longitudinally from the lower end of the lateral wall part (20-2) or (21-2) of the lead (20) or (21), whichever appropriate, so that the lateral wall part are completely divided or lead itself is divided into parts, the reactive current is reduced during the welding operation of the first welding step and the lead is welded more firmly to reduce the internal resistance. However, the reduction of resistance is offset by the increase of resistance due to the divided lead so that the internal resistance is not remarkably reduced after all. Additionally, the divided parts of the lead are difficult to handle and process. Therefore, the slits formed at circumferential intervals preferably do not completely divide the lead.

The contact resistance of the lead (20) or (21) becomes uneven to make an electric current flow unevenly through the lead when projections (20-3), (20-7) and (30-1) or (21-3), (21-6) and (31-1), whichever appropriate, are not formed on the welding surface of the lead (20) or (21). Therefore, projections are preferably formed so that they may be individually reliably and uniformly welded.

When the first welding step and the second welding step are inverted so that the flange portion (30) of the lead (20) and the upper current collecting plate (2) are welded in advance and the lid (50) and the top part (20-1) of the lead (20) are welded after crimping the lid (50) and hermetically sealing the battery, the lead (20) and the upper current collecting plate (2) were welded unevenly to make the battery show a low power output level.

It may be safe to assume that this is because the slits (20-4) for absorbing pressure are held rigid so that it is no longer possible to absorb the variance of the electrode assembly (70) such as a too large height or a too small height by means of uniform contact pressure and hence the lead is inevitably deformed.

As described above in detail, a sealed battery prepared by a method according to the present invention shows a low internal resistance of not higher than 1.02 mΩ and a high power output of not less than 1,400 W/kg.

A assembled battery formed by using a plurality of sealed batteries according to the present invention also shows a low internal resistance and a high power output density if compared with any known assembled battery.

The present invention is no limitations in terms of battery size and battery profile and can be applied to batteries of AA type, A type and sub C type.

### INDUSTRIAL APPLICABILITY

A sealed battery using a lead according to the present invention and a assembled battery formed by using a plurality of sealed batteries according to the present invention show a low internal resistance and a high power output and hence can find useful applications in electric motor vehicles and electric machine tools.

1. A lead for a sealed battery to be used by welding the inner surface of the lid of the sealed battery and the upper surface of an upper current collecting plate, characterized in that the lead comprises:
a plate-shaped top part;
a lateral wall part extending obliquely downwardly from the outer periphery of said top part so as to expand; and
that slits are longitudinally formed in said lateral wall part from the lower end at circumferential intervals.

2. The lead for a sealed battery according to claim 1, characterized in that the structure thereof is such that the lead portions put between the slits of said lateral wall part are bent to expand outwardly when said lid and said upper current collecting plate are pressurized.

3. The lead for a sealed battery according to claim 1, characterized in that two or more than two of said slits are formed at circumferential and regular intervals and the portions put between the slits of the lower end of said lateral wall part have respective projections for welding.

4. The lead for a sealed battery according to claim 1, characterized in that the lead further comprises a flange portion arranged at the outer periphery of the lower end of said lateral wall part and slits are longitudinally formed in said lateral wall part and said flange portion from the lower ends at circumferential intervals.

5. The lead for a sealed battery according to claim 4, characterized in that the structure thereof is such that the lead portions put between the slits of said lateral wall part and said flange portion are bent to expand outwardly when said lid and said upper current collecting plate are pressurized.

6. The lead for a sealed battery according to claim 4, characterized in that two or more than two of said slits are formed at circumferential and regular intervals and the portions put between the slits of said flange portion have respective projections for welding.

7. The lead for a sealed battery according to claim 1, characterized in that said top part has two or more than two projections for welding.

8. A lead for a sealed battery to be used by welding the inner surface of the lid of the sealed battery and the upper surface of an upper current collecting plate, characterized in that the lead comprises:
a plate-shaped frame part;
a lateral wall part extending obliquely downwardly from the inner periphery of said frame part so as to contract; and
that slits are longitudinally formed in said lateral wall part from the lower end at circumferential intervals.

9. The lead for a sealed battery according to claim 8, characterized in that the structure thereof is such that the lead portions put between the slits of said lateral wall part are bent to contract inwardly when said lid and said upper current collecting plate are pressurized.

10. The lead for a sealed battery according to claim 8, characterized in that two or more than two of said slits are formed at circumferential and regular intervals and the portions put between the slits of the lower end of said lateral wall part have respective projections for welding.

11. The lead for a sealed battery according to claim 8, characterized in that the lead further comprises a bottom portion projecting from the inner periphery of the lower end of said lateral wall part and slits are longitudinally formed in said lateral wall part and said bottom portion from the lower ends at circumferential intervals.

12. The lead for a sealed battery according to claim 11, characterized in that the structure thereof is such that the lead portions put between the slits of said lateral wall part and said bottom portion are bent to contract inwardly when said lid and said upper current collecting plate are pressurized.

13. The lead for a sealed battery according to claim 11, characterized in that two or more than two of said slits are formed at circumferential and regular intervals and the portions put between the slits of said bottom portion have respective projections for welding.

14. The lead for a sealed battery according to claim 8, characterized in that said frame part has two or more than two projections for welding.

15. A sealed battery containing an electrode assembly including a positive electrode plate and a negative electrode plate in a container and arranging an upper current collecting plate on said electrode assembly, the top surface of said upper current collecting plate electrically connected to one of the electrodes of said electrode assembly being welded to the inner surface of the lid by way of a lead, characterized in that said lead comprises:
a plate-shaped top part;
a lateral wall part extending obliquely downwardly from the outer periphery of said top part so as to expand;
that slits are longitudinally formed in said lateral wall part from the lower end at circumferential intervals; and
that the top part of said lead is welded to the inner surface of said lid and the lower end of the lateral wall part of said lead is welded to the upper surface of said upper current collecting plate.

16. The sealed battery according to claim 15, characterized in that the lead portions put between the slits of said lateral wall part are bent to expand outwardly.

17. The sealed battery according to claim 15, characterized in that two or more than two slits of said lead are formed at circumferential and regular intervals and points welded with the upper surface of said upper current collecting plate are arranged at the portions put between the slits of the lower end of the lateral wall part of said lead.

18. The sealed battery according to claim 15, characterized in that said lead further includes a flange portion arranged at the outer periphery of the lower end of said lateral wall part and slits are longitudinally formed in said lateral wall part and said flange portion from the lower end at circumferential intervals and that the flange portion of said lead is welded to the upper surface of said upper current collecting plate.

19. The sealed battery according to claim 18, characterized in that the lead portions put between the slits of said lateral wall part and said flange portion are bent to expand outwardly.

20. The sealed battery according to claim 18, characterized in that two or more than two slits of said lead are formed at circumferential and regular intervals and points welded with the upper surface of said upper current collecting plate are arranged at the portions put between the slits of the flange portion of said lead.

21. The sealed battery according to claim 15, characterized in that two ore more than two points welded are provided for welding the inner surface of said lid and the top part of said lead.

22. A sealed battery containing an electrode assembly including a positive electrode plate and a negative electrode plate in a container and arranging an upper current collecting plate on said electrode assembly, the top surface of said upper current collecting plate electrically connected to one of the electrodes of said electrode assembly being welded to the inner surface of the lid by way of a lead, characterized in that said lead comprises:
a plate-shaped frame part;
a lateral wall part extending obliquely downwardly from the inner periphery of said frame part so as to contract;
that slits are longitudinally formed in said lateral wall part from the lower end at circumferential intervals; and
that the frame part of said lead is welded to the inner surface of said lid and the lower end of the lateral wall part of said lead is welded to the upper surface of said upper current collecting plate.

23. The sealed battery according to claim 22, characterized in that the lead portions put between the slits of said lateral wall part are bent to contract inwardly.

24. The sealed battery according to claim 22, characterized in that two or more than two slits of said lead are formed at circumferential and regular intervals and points welded with the upper surface of said upper current collecting plate are arranged at the portions put between the slits of the lower end of the lateral wall part of said lead.

25. The sealed battery according to claim 22, characterized in that said lead further includes a bottom portion projecting from the inner periphery of the lower end of said lateral wall part and slits are longitudinally formed in said lateral wall part and said bottom portion from the lower ends at circumferential intervals and that the bottom portion of said lead is welded to the upper surface of said upper current collecting plate.

26. The sealed battery according to claim 25, characterized in that the lead portions put between the slits of said lateral wall part and said bottom portion are bent to contract inwardly.

27. The sealed battery according to claim 25, characterized in that two or more than two slits of said lead are formed at circumferential and regular intervals and points welded with the upper surface of said upper current collecting plate are arranged at the portions put between the slits of the bottom portion of said lead.

28. The sealed battery according to claim 22, characterized in that two ore more than two points welded are provided for welding the inner surface of said lid and the frame part of said lead.

29. A assembled battery characterized by being comprised of a plurality of sealed batteries according to claim 15.

30. A method of manufacturing a sealed battery in which the inner surface of the lid closing the container of the sealed battery and the upper surface of the upper current collecting plate are connected by way of a lead, characterized by comprising:
a first welding step of bringing in a thing as said lead which has a plate-shaped top part, a lateral wall part extending obliquely downwardly from the outer periphery of said top part so as to expand and slits being longitudinally formed in said lateral wall part from the lower end at circumferential intervals, and welding the top part of said lead to the inner surface of said lid; and
a second welding step of subsequently putting an electrode assembly bonded with the upper current collecting plate in said container so as to make said upper current collecting plate located at the open end side of said container, injecting an electrolyte solution, mounting said lid so as to make the lower end of the lateral wall part of said lead contact the upper surface of said upper current collecting plate, hermitically closing said container, pressurizing, and then welding the lower end of the lateral wall part of said lead to the upper surface of said upper current collecting plate by passing a welding electric current between the positive and negative terminals of the sealed battery by way of the battery.

31. The method of manufacturing a sealed battery according to claim 30, characterized in that the lead further includes a flange portion arranged at the outer periphery of the lower end of said lateral wall part and slits are longitudinally formed in said lateral wall part and said flange portion from the lower end at circumferential intervals and that the flange portion of said lead is welded to the upper surface of said upper current collecting plate.

32. The method of manufacturing a sealed battery according to claim 30, characterized in that the lead portions put between the slits of said lateral wall part or said lateral wall part and said flange portion are bent to expand outwardly and absorb a deformation when said lid and said upper current collecting plate are pressurized.

33. A method of manufacturing a sealed battery in which the inner surface of the lid closing the container of the sealed battery and the upper surface of the upper current collecting plate are connected by way of a lead, characterized by comprising:
a first welding step of bringing in a thing as said lead which has a plate-shaped frame part, a lateral wall part extending obliquely downwardly from the inner periphery of said frame part so as to contract and slits being longitudinally formed in said lateral wall part from the lower end at circumferential intervals, and welding the frame part of said lead to the inner surface of said lid; and
a second welding step of subsequently putting an electrode assembly bonded with the upper current collecting plate in said container so as to make said upper current collecting plate located at the open end side of said container, injecting an electrolyte solution, mounting said lid so as to make the lower end of the lateral wall part of said lead contact the upper surface of said upper current collecting plate, hermitically closing said container, pressurizing, and then welding the lower end of the lateral wall part of said lead to the upper surface of said upper current collecting plate by passing a welding electric current between the positive and negative terminals of the sealed battery by way of the battery.

34. The method of manufacturing a sealed battery according to claim 33, characterized in that the lead further includes a bottom portion projecting from the inner periphery of the lower end of said lateral wall part and slits are longitudinally formed in said lateral wall part and said bottom portion from the lower ends at circumferential intervals and that the bottom portion of said lead is welded to the upper surface of said upper current collecting plate.

35. The method of manufacturing a sealed battery according to claim 33, characterized in that the lead portions put between the slits of said lateral wall part or said lateral wall part and said bottom portion are bent to contract inwardly and absorb a deformation when said lid and said upper current collecting plate are pressurized.
